(19) United States
(12) Patent Application Publication
(10) Pub. No.: US 2025/0076654 A1
(43) Pub. Date: Mar. 6, 2025

(54) RETINAL PROJECTION DEVICE

(71) Applicant: TDK Corporation, Tokyo (JP)

(72) Inventors: Takashi ASATANI, Tokyo (JP); Masahiro SHINKAI, Tokyo (JP)

(73) Assignee: TDK Corporation, Tokyo (JP)

(21) Appl. No.: 18/814,744

(22) Filed: Aug. 26, 2024

(30) Foreign Application Priority Data
Aug. 29, 2023 (JP) 2023-138955

(51) Int. Cl. G02B 27/01; G02B 27/00; G02B 27/28

(52) U.S. Cl. CPC G02B 27/0172; G02B 27/0075; G02B 27/0093; G02B 27/286; G02B 27/288; G02B 2027/0112; G02B 2027/0174; G02B 2027/0187

(57) ABSTRACT

A retinal projection device includes: a projector module including a laser module that emits laser light, a collimation lens that converts the laser light into a parallel beam, and a movable mirror that performs scanning by the beam; a projection lens that focuses the beam emitted from the projector module at a focusing position; an optical unit including a deflector, which changes a traveling direction of the beam, arranged so as to overlap the focusing position; an optical device that converts the beam into parallel light and irradiate a retina of a user with the parallel light; and a controller that adjusts the traveling direction of the beam by the deflector in accordance with a position of a pupil of the user.

### CROSS-REFERENCE TO RELATED APPLICATION

This application is based on Japanese Patent Application No. 2023-138955 filed with the Japan Patent Office on Aug. 29, 2023 and claims the benefit of priority thereto. The entire contents of the Japanese patent application are incorporated herein by reference.

### TECHNICAL FIELD

The present disclosure relates to a retinal projection device.

### BACKGROUND

A retinal projection device for directly projecting an image onto a retina of a user is known (see, for example, US 2019/0361250 A1, JP 2021-5072 A, and WO 2019/146367 A1).

### SUMMARY

In the retinal projection devices disclosed in US 2019/0361250 A1, JP 2021-5072 A and WO 2019/146367 A1, the user may not be able to correctly recognize an image when the user moves the user's eyes. In the present technical field, it is desired to expand the movable range (eye box) of the eye in which a user can correctly recognize an entire image.

The present disclosure describes a retinal projection device capable of expanding an eye box.

A retinal projection device according to one aspect of the present disclosure includes: a projector module including a laser module that emits laser light, a collimation lens that converts the laser light into a parallel beam, and a movable mirror that performs scanning by the beam; a projection lens that focuses the beam emitted from the projector module at a focusing position; an optical unit including a deflector, which changes a traveling direction of the beam, arranged so as to overlap the focusing position; an optical device that converts the beam into parallel light and irradiate a retina of a user with the parallel light; and a controller that adjusts the traveling direction of the beam by the deflector in accordance with a position of a pupil of the user.

In the retinal projection device, the optical unit including the deflector is arranged so as to overlap the focusing position, and the traveling direction of the beam by the deflector is adjusted in accordance with the position of the pupil of the user. According to this configuration, even if the user moves the user's eye, the traveling direction of the beam can be changed following the movement of the pupil of the user. Since the deflector is disposed in the vicinity of the focusing position, spherical aberration caused by the change in the traveling direction of the beam (deflection) is reduced. Therefore, since the quality of imaging on the retina is maintained, the user can correctly recognize the image. As a result, the eye box can be expanded.

In some embodiments, the above-described retinal projection device may further include a first wave plate that is provided between the laser module and the deflector and converts linearly polarized light into circularly polarized light. The deflector may include: one or more second wave plates capable of switching between a state in which a polarization state of circularly polarized light is preserved and a state in which circularly polarized light is converted into circularly polarized light having an opposite polarity in accordance with an applied voltage; and one or more Pancharatnam-Berry phase optical elements that convert circularly polarized light into circularly polarized light having an opposite polarity and diffract the circularly polarized light in a diffraction direction in accordance with a polarity of incident circularly polarized light. The one or more second wave plates and the one or more Pancharatnam-Berry phase optical elements may be alternately arranged one by one to form an array. According to this configuration, the polarity (polarization state) of the circularly polarized light passing through the second wave plate can be switched by switching the second wave plate between a state in which the polarization state of the circularly polarized light is preserved and a state in which the circularly polarized light is converted into a circularly polarized light having an opposite polarity. In accordance with the polarity of the circularly polarized light, the diffraction direction in the Pancharatnam-Berry phase optical element provided in the subsequent stage of the second wave plate is determined. Therefore, the traveling direction of the beam can be changed by the voltage applied to the second wave plate.

In some embodiments, the deflector may further include a reflector that reflects the circularly polarized light while preserving the polarity of the circularly polarized light. The reflector may be provided at one end of the array. In this case, the beam which has passed through the array is reflected by the reflector to pass through the array again. This makes it possible to increase the number of traveling directions that can be changed by the deflector.

In some embodiments, the one or more Pancharatnam-Berry phase optical elements may be constituted by liquid crystal polymers or metasurfaces. By using liquid crystal polymers or metasurfaces, the Pancharatnam-Berry phase optical elements can be easily formed.

In some embodiments, each of the second wave plates may include a pair of transparent electrodes and a liquid crystal layer provided between the pair of transparent electrodes. In this case, by applying a voltage between the pair of transparent electrodes, an electric field is generated in the liquid crystal layer, and liquid crystal molecules contained in the liquid crystal layer are oriented in the direction of the electric field. Therefore, in a state where a voltage is applied between the pair of transparent electrodes, the second wave plate preserves the polarization state of the circularly polarized light passing through the second wave plate. In a state where no voltage is applied between the pair of transparent electrodes, the liquid crystal molecules contained in the liquid crystal layer are in an in-plane orientation state. At this time, the second wave plate converts the circularly polarized light passing through the second wave plate into a circularly polarized light having an opposite polarity. In this way, depending on whether or not a voltage is applied between the pair of transparent electrodes, it is possible to switch between a state in which the polarization state of circularly polarized light is preserved and a state in which circularly polarized light is converted into circularly polarized light having an opposite polarity.

In some embodiments, the above-described retinal projection device may further include a wavefront correction unit that corrects a wavefront aberration of a light ray passing through the pupil among light rays constituting the beams. In this case, the resolution at the center of the field of view can be improved.

In some embodiments, the wavefront correction unit may be constituted by one of an LCOS, a liquid crystal lens, and a deformable mirror. By using one of these devices, the wavefront correction unit can be easily realized.

In some embodiments, the above-described retinal projection device may further include a focusing area that is provided between the optical unit and the optical device to focus the beam. In this case, the optical unit may be provided at a position away from the optical device. Therefore, the degree of freedom in the arrangement of the optical unit can be improved.

In some embodiments, the laser module may emit the laser light obtained by multiplexing a red laser light having a red wavelength, a green laser light having a green wavelength, and a blue laser light having a blue wavelength. In this case, a full-color retinal projection device can be realized.

In some embodiments, the above-described retinal projection device may further include a filter that: passes circularly polarized light having a first polarity in light having the red wavelength; reflects circularly polarized light having a second polarity different from the first polarity in the light having the red wavelength; passes circularly polarized light having the second polarity in light having the green wavelength; reflects circularly polarized light having the first polarity in the light having the green wavelength; passes circularly polarized light having the first polarity in light of the blue wavelength; and reflects circularly polarized light having the second polarity in the light of the blue wavelength. The optical device may be a holographic combiner. The optical device may include: a first holographic diffraction layer that diffracts circularly polarized light having the first polarity in a first wavelength range including the red wavelength; a second holographic diffraction layer that diffracts circularly polarized light having the second polarity in a second wavelength range including the green wavelength; and a third holographic diffraction layer that diffracts circularly polarized light having the first polarity in a third wavelength range including the blue wavelength.

In order to expand the eye box, it is necessary to widen the allowable range of the incident angle of the beam entering the holographic combiner. When a wide-band element having a wide allowable range of incident angle is used, the allowable range of wavelength is widened. In this case, stray light due to chromatic aberration may occur. On the other hand, the filter extracts circularly polarized light having the first polarity from the light having the red wavelength, extracts circularly polarized light having the second polarity from the light having the green wavelength, and extracts circularly polarized light having the first polarity from the light having the blue wavelength. Since the first holographic diffraction layer diffracts circularly polarized light having the first polarity, circularly polarized light of the second polarity having the green wavelength is hardly diffracted even if the allowable range of wavelength of the first holographic diffraction layer is widened. Similarly, since the second holographic diffraction layer diffracts circularly polarized light having the second polarity, circularly polarized light of the first polarity having the red wavelength and circularly polarized light of the first polarity having the blue wavelength are hardly diffracted even if the allowable range of wavelength of the second holographic diffraction layer is widened. Similarly, since the third holographic diffraction layer diffracts circularly polarized light having the first polarity, circularly polarized light of the second polarity having the green wavelength is hardly diffracted even if the allowable range of wavelength of the third holographic diffraction layer is widened. Therefore, it is possible to reduce the possibility that stray light occurs due to chromatic aberration.

In some embodiments, the first holographic diffraction layer may be constituted by a cholesteric liquid crystal polymer layer having a helical structure having a helical pitch corresponding to the red wavelength, the helical structure twisted in a twisting direction capable of reflecting circularly polarized light having the first polarity. The second holographic diffraction layer may be constituted by a cholesteric liquid crystal polymer layer having a helical structure having a helical pitch corresponding to the green wavelength, the helical structure twisted in a twisting direction capable of reflecting circularly polarized light having the second polarity. The third holographic diffraction layer may be constituted by a cholesteric liquid crystal polymer layer having a helical structure having a helical pitch corresponding to the blue wavelength, the helical structure twisted in a twisting direction capable of reflecting circularly polarized light having the first polarity.

When the twisting direction of the twisted structure of the electric field vector having the light traveling direction as an axis at a certain time caused by the rotation of the electric field vector of circularly polarized light coincides with the twisting direction of the twisted structure in the orientation direction of the liquid crystal molecules of the cholesteric liquid crystal polymer layer, and the incident light satisfies a certain condition, the Bragg reflection occurs and the incident light is diffracted and reflected. On the other hand, if the above-described twisting directions are opposite to each other, the incident light is transmitted without the Bragg reflection. The first holographic diffraction layer is configured to reflect circularly polarized light of the first polarity having the red wavelength, the second holographic diffraction layer is configured to reflect circularly polarized light of the second polarity having the green wavelength, and the third holographic diffraction layer is configured to reflect circularly polarized light of the first polarity having the blue wavelength. Therefore, the above-described function of the optical device can be realized.

In some embodiments, the filter may include: a first filter layer constituted by a first cholesteric liquid crystal polymer layer having a helical structure having a helical pitch corresponding to the red wavelength, the helical structure twisted in a twisting direction capable of reflecting circularly polarized light having the second polarity; a second filter layer constituted by a second cholesteric liquid crystal polymer layer having a helical structure having a helical pitch corresponding to the green wavelength, the helical structure twisted in a twisting direction capable of reflecting circularly polarized light having the first polarity; and a third filter layer constituted by a third cholesteric liquid crystal polymer layer having a helical structure having a helical pitch corresponding to the blue wavelength, the helical structure twisted in a twisting direction capable of reflecting circularly polarized light having the second polarity.

When the twisting direction of the twisted structure of the electric field vector having the light traveling direction as an axis at a certain time caused by the rotation of the electric field vector of circularly polarized light coincides with the twisting direction of the twisted structure in the orientation direction of the liquid crystal molecules of the cholesteric liquid crystal polymer layer, and the incident light satisfies a certain condition, the Bragg reflection occurs and the incident light is diffracted and reflected. On the other hand, if the above-described twisting directions are opposite to each other, the incident light is transmitted without the Bragg reflection. The first filter layer is configured to reflect circularly polarized light having the second polarity from light having the red wavelength, the second filter layer is configured to reflect circularly polarized light having the first polarity from light having the green wavelength, and the third filter layer is configured to reflect circularly polarized light having the second polarity from light having the blue wavelength. Since this makes it possible to extract circularly polarized light of the first polarity having the red wavelength, circularly polarized light of the second polarity having the green wavelength, and circularly polarized light of the first polarity having the blue wavelength, the above-described function of the filter can be realized.

According to each aspect and each embodiment of the present disclosure, the eye box can be expanded.

### BRIEF DESCRIPTION OF THE DRAWINGS

FIG. 1 is a diagram showing a basic configuration of a retinal projection device according to an embodiment.

FIG. 2 is a diagram schematically showing the configuration of the deflector shown in FIG. 1.

FIG. 3 is a diagram schematically showing the configuration of the wave plate shown in FIG. 2.

FIG. 4 is a diagram schematically showing the configuration of the Pancharatnam-Berry phase optical element shown in FIG. 2.

FIG. 5 is a cross-sectional view taken along the line V-V of FIG. 4.

FIG. 6 is a diagram for explaining the operation of the deflector shown in FIG. 2.

FIG. 7 is a diagram for explaining the operation of the deflector shown in FIG. 2.

FIG. 8 is a diagram for explaining the operation of the deflector shown in FIG. 2.

FIG. 9 is a diagram for explaining the operation of the deflector shown in FIG. 2.

FIG. 10 is a diagram for explaining the change in wave vector due to deflection.

FIG. 11 is a diagram for explaining that the focusing position differs depending on the axial direction.

FIG. 12 is a diagram showing a basic configuration of a retinal projection device according to a modified example.

FIG. 13 is a diagram showing an application example of the retinal projection device shown in FIG. 1.

FIG. 14 is a diagram showing another application example of the retinal projection device shown in FIG. 1.

FIG. 15 is a diagram showing yet another application example of the retinal projection device shown in FIG. 1.

FIG. 16 is a diagram showing yet another application example of the retinal projection device shown in FIG. 1.

FIG. 17 is a diagram schematically showing the configuration of the deflector shown in FIG. 16.

FIG. 18 is a diagram for explaining the operation of the deflector shown in FIG. 16.

FIG. 19 is a diagram showing yet another application example of the retinal projection device shown in FIG. 1.

FIG. 20 is a diagram schematically showing the configuration of the notch filter shown in FIG. 19.

FIG. 21 is a diagram for explaining the principle of the notch filter shown in FIG. 19.

FIG. 22 is a diagram for explaining the principle of the notch filter shown in FIG. 19.

FIG. 23 is a diagram for explaining the principle of the reflector shown in FIG. 19.

FIG. 24 is a diagram for explaining the principle of the reflector shown in FIG. 19.

### DETAILED DESCRIPTION

Hereinafter, embodiments of the present disclosure will be described in detail with reference to the drawings. In the description of the drawings, the same elements are denoted by the same reference numerals, and redundant description will be omitted. In each figure, an XYZ coordinate system may be shown. The Y-axis direction is a direction intersecting (for example, orthogonal to) the X-axis direction and the Z-axis direction. The Z-axis direction is a direction intersecting (for example, orthogonal to) the X-axis direction and the Y-axis direction.

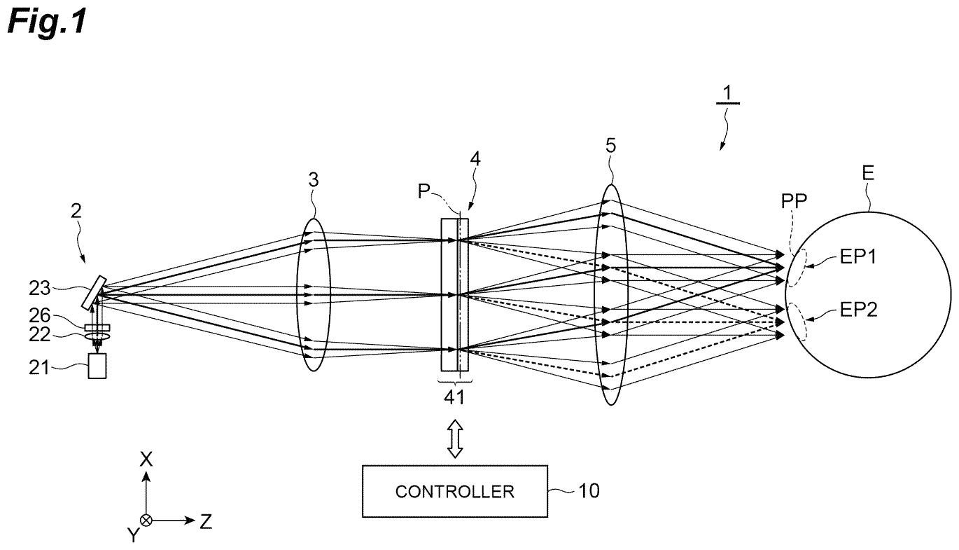

A retinal projection device according to an embodiment will be described with reference to FIG. 1. FIG. 1 is a diagram showing a basic configuration of a retinal projection device according to an embodiment. A retinal projection device 1 shown in FIG. 1 is a device for directly projecting (drawing) an image onto a retina of a user. The retinal projection device 1 is mounted on, for example, a near-eye wearable device. Examples of the near-eye wearable device include smart glasses such as augmented reality (AR) glasses, virtual reality (VR) glasses, and mixed reality (MR) glasses. The retinal projection device 1 includes a projector module 2, a projection lens 3, an optical unit 4, an optical device 5, and a controller 10.

The projector module 2 is a module for performing scanning by a beam. The projector module 2 includes a laser module 21, a collimation lens 22, a movable mirror 23, and a wave plate 26 (first wave plate).

The laser module 21 emits laser light having a color and intensity corresponding to a pixel of an image to be projected onto the retina. As the laser module 21, for example, a full-color laser module is used. In this case, the laser module 21 includes a red laser diode, a green laser diode, a blue laser diode, and a multiplexer that multiplexes laser lights emitted from laser diodes into one laser light. As the multiplexer, for example, a planar lightwave circuit (PLC) is used. The laser module 21 emits a laser light obtained by multiplexing a red laser light having a red wavelength, a green laser light having a green wavelength, and a blue laser light having a blue wavelength.

The collimation lens 22 is an optical element for converting the laser light emitted from the laser module 21 into a parallel beam. The movable mirror 23 is a member for performing scanning by the beam converted by the collimation lens 22. The movable mirror 23 is provided in the emission direction of the beam converted by the collimation lens 22. As the movable mirror 23, for example, a micro electro mechanical systems (MEMS) mirror is used.

The wave plate 26 is an optical element for converting linearly polarized light into circularly polarized light. Since the laser module 21 generally emits linearly polarized light, it is necessary to convert the linearly polarized light into circularly polarized light until the light reaches the Pancharatnam-Berry phase optical element 44 (described later) in the optical unit 4. Therefore, the wave plate 26 is disposed between the laser module 21 and the optical unit 4. The wave plate 26 may be disposed immediately after the collimation lens 22, for example. When an element assuming operation with linearly polarized light is disposed between the laser module 21 and the optical unit 4, the wave plate 26 is disposed in the subsequent stage of the element assuming operation with linearly polarized light. As the wave plate 26, a true quarter-wave plate is used in consideration of wavelength dispersion and the like, but a ¼+N (N is a natural number) wave plate may be used.

The projector module 2 further includes a laser driver (not shown) for driving the laser module 21, and a mirror driver (not shown) for driving the movable mirror 23.

The projection lens 3 is an optical element for focusing the beam emitted from the projector module 2 at a focusing position P. The focusing position P is a position where the beam is focused in a cross section including the central axis of the beam. When the beam is focused on one point, the focusing position P is an intermediate imaging plane. Here, in order to simplify the description, a case where the focusing position P is an intermediate imaging plane is exemplified.

The optical unit 4 is a unit for changing the traveling direction of the beam in accordance with the position of the pupil PP of the user. The position of the pupil PP is the position of the pupil PP in the eyeball E, and may also be expressed as the direction of the pupil PP or the gaze direction. The optical unit 4 is disposed so as to overlap the focusing position P. The optical unit 4 includes a deflector 41. The deflector 41 is an optical element for changing the traveling direction of the beam. Details of the deflector 41 will be described later.

The optical device 5 is an optical element for converting a beam into parallel light to apply the parallel light to a retina of a user. The optical device 5 may be an eyepiece or a combiner.

The controller 10 is a device for integrally controlling the retinal projection device 1. The controller 10 adjusts the traveling direction of the beam by the deflector 41 in accordance with the position of the pupil PP of the user. The controller 10 adjusts the traveling direction of the beam, for example, by changing the voltage applied to the deflector 41. The retinal projection device 1 may further include a detector (not shown) for detecting the position of the pupil PP. In FIG. 1, a position EP1 and a position EP2 are exemplified as the position of the pupil PP.

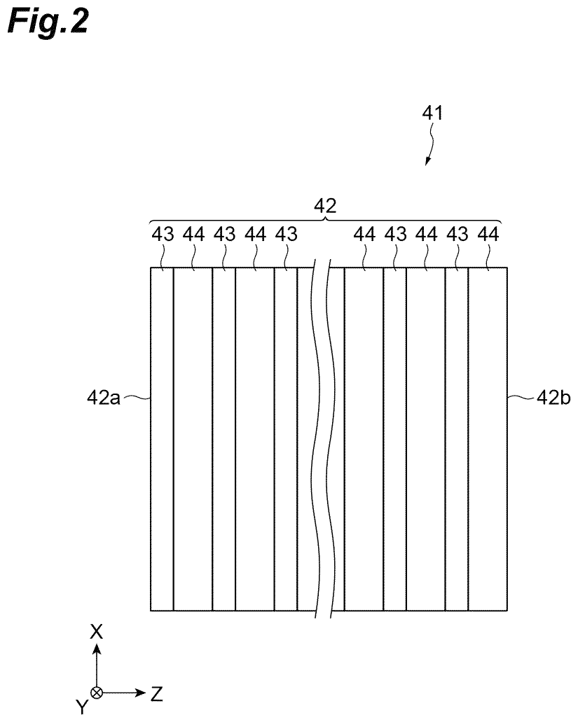

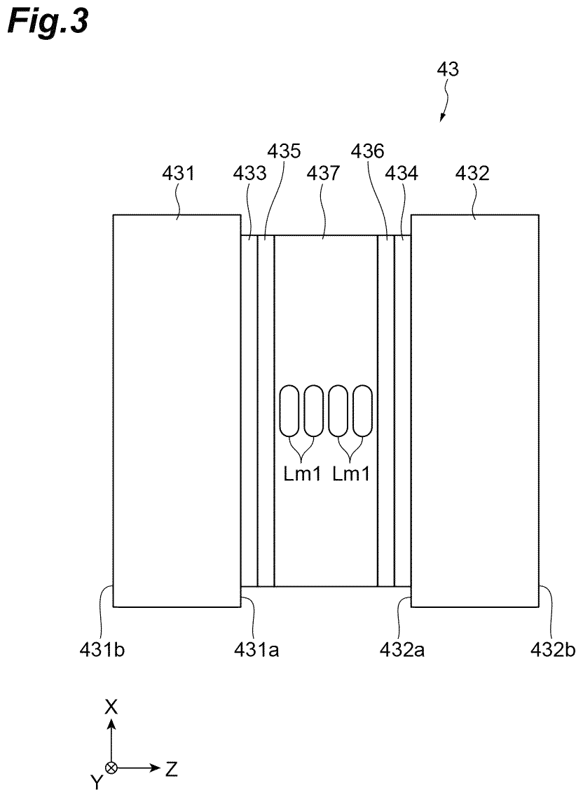

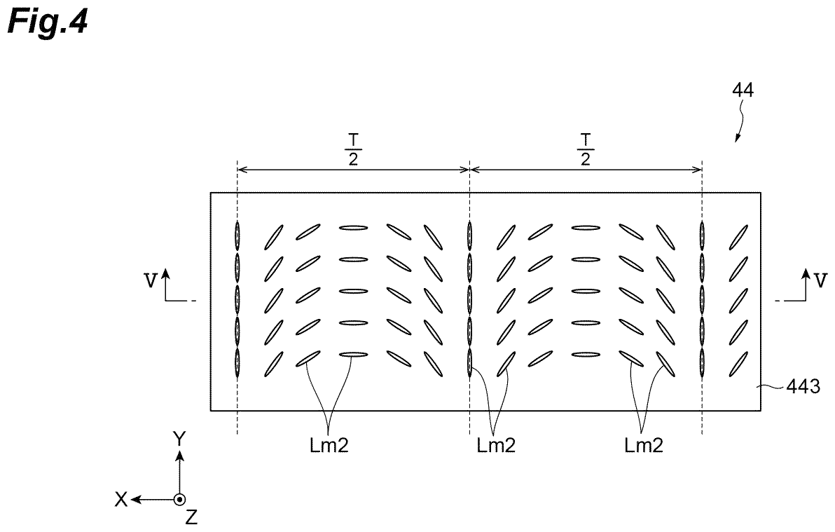

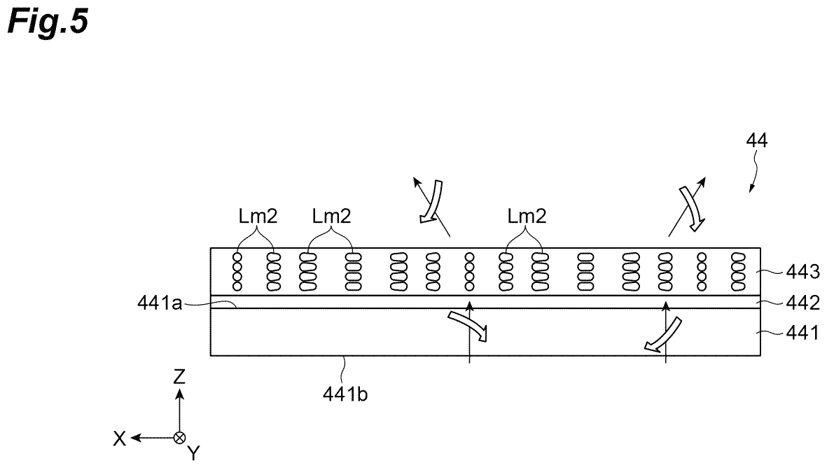

Next, the deflector 41 will be described in detail with reference to FIGS. 2 to 5. FIG. 2 is a diagram schematically showing the configuration of the deflector shown in FIG. 1. FIG. 3 is a diagram schematically showing the configuration of the wave plate shown in FIG. 2. FIG. 4 is a diagram schematically showing the configuration of the Pancharatnam-Berry phase optical element (hereinafter also referred to as “PBOE”) shown in FIG. 2. FIG. 5 is a cross-sectional view taken along the line V-V of FIG. 4.

As shown in FIG. 2, the deflector 41 is a transmissive deflector, and includes one or more wave plates 43 (second wave plates) and one or more PBOEs 44. The number of the wave plates 43 included in the deflector 41 is equal to the number of the PBOEs 44 included in the deflector 41.

The wave plate 43 is an optical element capable of switching between a state in which the polarization state (polarity) of the circularly polarized light passing through the wave plate 43 is preserved (maintained) and a state in which the circularly polarized light passing through the wave plate 43 is converted into a circularly polarized light having an opposite polarity in accordance with a voltage applied to the wave plate 43. The wave plate 43 has, for example, a rectangular plate shape. As shown in FIG. 3, the wave plate 43 includes a transparent substrate 431, a transparent substrate 432, a transparent electrode 433, a transparent electrode 434, an alignment layer 435, an alignment layer 436, and a liquid crystal layer 437.

Each of the transparent substrate 431 and the transparent substrate 432 is a substrate having a visible light transmission property which transmits visible light. The transparent substrate 431 and the transparent substrate 432 are made of a constituent material having a low birefringence. Examples of the constituent material of the transparent substrate 431 and the transparent substrate 432 include SiO₂, optical glass, and a glass substrate for a liquid crystal display. The transparent substrate 431 and the transparent substrate 432 are spaced apart from each other in the Z-axis direction and arranged substantially parallel to each other. The transparent substrate 431 has a surface 431a and a surface 431b intersecting (here, orthogonal to) the Z-axis direction. The transparent substrate 432 has a surface 432a and a surface 432b intersecting (here, orthogonal to) the Z-axis direction. The surface 431a and the surface 432a face each other in the Z-axis direction. The surface 431b is the opposite surface of the surface 431a. The surface 432b is the opposite surface of the surface 432a.

Each of the transparent electrode 433 and the transparent electrode 434 (a pair of transparent electrodes) is an electrode having electrical conductivity and a visible light transmission property which transmits visible light. An example of a constituent material of the transparent electrode 433 and the transparent electrode 434 is ITO (Indium Tin Oxide). The transparent electrode 433 and the transparent electrode 434 face each other in the Z-axis direction with the liquid crystal layer 437 therebetween. The transparent electrode 433 is provided on the surface 431a. The transparent electrode 434 is provided on the surface 432a. A voltage is applied to the transparent electrode 433 and the transparent electrode 434.

Each of the alignment layer 435 and the alignment layer 436 is a layer for controlling the alignment state (orientation) of the liquid crystal molecules Lm1 contained in the liquid crystal layer 437. The alignment layer 435 is provided on a surface of the transparent electrode 433 facing the transparent electrode 434. The alignment layer 436 is provided on a surface of the transparent electrode 434 facing the transparent electrode 433.

The liquid crystal layer 437 is provided between the alignment layer 435 and the alignment layer 436. In other words, the liquid crystal layer 437 is provided between the transparent electrode 433 and the transparent electrode 434. An example of a constituent material of the liquid crystal layer 437 is a nematic liquid crystal. The orientation of the liquid crystal molecules Lm1 is controlled in accordance with the electric field applied to the liquid crystal layer 437, so that the optical characteristic of the liquid crystal layer 437 changes.

In the wave plate 43, the beam enters the transparent substrate 431 from the surface 431b, passes through the transparent substrate 431, the transparent electrode 433, the alignment layer 435, the liquid crystal layer 437, the alignment layer 436, the transparent electrode 434, and the transparent substrate 432 in this order, and exits from the surface 432b.

Since the liquid crystal material is in contact with the alignment layer 435 and the alignment layer 436, the liquid crystal molecules Lm1 are in the in-plane orientation state when no voltage is applied between the transparent electrode 433 and the transparent electrode 434 (voltage non-application state). That is, the slow axis of each liquid crystal molecule Lm1 is substantially parallel to the planes of the alignment layer 435 and the alignment layer 436 in contact with the liquid crystal layer 437. At this time, the length (thickness) of the liquid crystal layer 437 in the Z-axis direction is adjusted so that the wave plate 43 functions as a half-wave plate (that is, the circularly polarized light passing through the wave plate 43 is converted into circularly polarized light having an opposite polarity).

When a voltage is applied between the transparent electrode 433 and the transparent electrode 434, an electric field in the Z-axis direction is generated in the liquid crystal layer 437, and the liquid crystal molecules Lm1 are oriented in the Z-axis direction. That is, the slow axis of each liquid crystal molecule Lm1 is substantially perpendicular to the planes of the alignment layer 435 and the alignment layer 436 in contact with the liquid crystal layer 437. Therefore, in a state where a voltage is applied between the transparent electrode 433 and the transparent electrode 434 (voltage application state), the wave plate 43 preserves the polarization state of the circularly polarized light passing through the wave plate 43.

The PBOE 44 is an optical element that converts the circularly polarized light passing through the PBOE 44 into circularly polarized light having an opposite polarity and diffracts the circularly polarized light in a diffraction direction corresponding to the polarity of the circularly polarized light incident on the PBOE 44. The PBOE 44 has, for example, a rectangular plate shape. As shown in FIGS. 4 and 5, the PBOE 44 includes a transparent substrate 441, an alignment layer 442, and a liquid crystal layer 443 (liquid crystal polymer).

The transparent substrate 441 is a substrate having a visible light transmission property which transmits visible light. The transparent substrate 441 is made of a constituent material having surface accuracy and low birefringence. Examples of the constituent material of the transparent substrate 441 include SiO₂, optical glass, and a glass substrate for a liquid crystal display. The transparent substrate 441 has a surface 441a and a surface 441b intersecting (here, orthogonal to) the Z-axis direction.

The alignment layer 442 is a layer for controlling the alignment state (orientation) of the liquid crystal molecules Lm2 contained in the liquid crystal layer 443. The alignment layer 442 is provided on the surface 441a. Examples of the constituent material of the alignment layer 442 include a material in which the orientation of molecules is changed by applying polarized light.

The liquid crystal layer 443 is provided on the alignment layer 442. Examples of the constituent material of the liquid crystal layer 443 include nematic liquid crystal and cholesteric liquid crystal. The liquid crystal layer 443 is made of a liquid crystal polymer obtained by orienting liquid crystal molecules using photo-polymerizable liquid crystal molecules and then polymerizing the liquid crystal molecules. A method for manufacturing the PBOE 44 will be described in detail later.

The plurality of liquid crystal molecules Lm2 contained in the liquid crystal layer 443 are three dimensionally arranged in the X-axis direction, the Y-axis direction and the Z-axis direction. In the X-axis direction, for example, the plurality of liquid crystal molecules Lm2 are arranged such that an angle (orientation angle) between the slow axis of each liquid crystal molecule Lm2 and the X-axis direction gradually increases or decreases. Specifically, in the X-axis direction, the plurality of liquid crystal molecules Lm2 are arranged such that the orientation angles gradually increase from 0 degree to 180 degrees within a range corresponding to the period T of the diffraction grating. In the Y-axis direction and the Z-axis direction, the plurality of liquid crystal molecules Lm2 are arranged so that the orientation angles of the liquid crystal molecules Lm2 are the same. Since the phase changes by −360 degrees, that is, by one wavelength at the rotation of the orientation angle of 180 degrees, the rotation of the orientation angle of 180 degrees corresponds to one period T of the diffraction grating.

According to the above configuration, the PBOE 44 functions as a diffraction grating that diffracts circularly polarized light at a constant diffraction angle. For example, circularly polarized light enters the transparent substrate 441 from the surface 441b and passes through the transparent substrate 441, the alignment layer 442, and the liquid crystal layer 443 in this order. At this time, due to the birefringence index of the liquid crystal molecules Lm2 contained in the liquid crystal layer 443, the circularly polarized light gradually changes to the circularly polarized light having the opposite polarity. At that time, the relative phase of the circularly polarized light having the opposite polarity to the incident circularly polarized light changes depending on the orientation angles of the liquid crystal molecules Lm2, and the change amount is equal to −2 times the change amount in the orientation angles of the liquid crystal molecules Lm2 (assuming that the rotation direction of the electric field vector of the incident circularly polarized light is positive). Here, the orientation angle and the phase angle are considered in radians. As a result, the phase difference depending on the position where the circularly polarized light having the opposite polarity passes can be given to the circularly polarized light. That means the inclination of the wavefront can be generated, therefore the PBOE 44 functions as a diffraction grating. It should be noted that the diffraction directions of the left-handed circularly polarized light (circularly polarized light having first polarity) and the right-handed circularly polarized light (circularly polarized light having second polarity) are opposite to each other. When the deflector 41 includes a plurality of PBOEs 44, the diffraction angles by the PBOEs 44 may be different from each other.

The length (thickness) of the liquid crystal layer 443 in the Z-axis direction is set so that the phase difference due to the birefringence of the liquid crystal is 180 degrees, that is, the PBOE 44 functions as a half-wave plate in which the slow axes change in the in-plane direction. As a result, the diffraction efficiency reaches nearly 100%. In this case, almost no 0 order (straight light) is generated. In the PBOE 44, diffracted light of a second order or higher order is not generated.

The wave plates 43 and the PBOEs 44 are alternately arranged one by one in the Z-axis direction to form an array 42. The array 42 has a first end 42a and a second end 42b which are both ends in the Z-axis direction. A wave plate 43 is disposed at the first end 42a, and a PBOE 44 is disposed at the second end 42b. When the deflector 41 is disposed near the intermediate imaging plane, the PBOE 44 near the intermediate imaging plane among the PBOEs 44 included in the deflector 41 may be configured to have a function of a field lens.

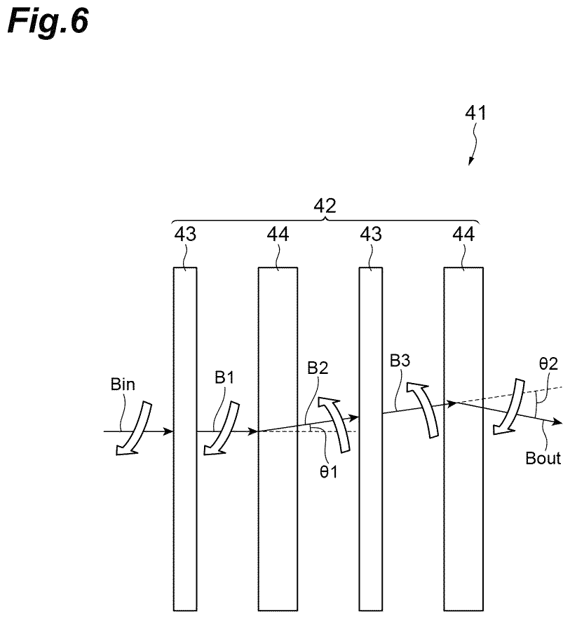

Next, the beam steering (beam deflection) by the deflector 41 will be described with reference to FIGS. 6 to 9. FIGS. 6 to 9 are diagrams for explaining the operation of the deflector shown in FIG. 2. Here, for convenience of description, a case where the deflector 41 includes two wave plates 43 and two PBOEs 44 and the beam Bin of the left-handed circularly polarized light enters the deflector 41 will be exemplified. The diffraction angle on the left side (upward in FIGS. 6 to 9) with respect to the incident direction of the beam Bin is set to a positive value.

In the following description, it is assumed that the diffraction angle of the PBOE 44 does not depend on the incident angle on the PBOE 44. This assumption holds as a good approximation when the diffraction angle of the PBOE 44 is small. Actually, in the PBOE 44, the in-plane direction components of the wave vector of the incident light are changed by an intrinsic wave vector in the in-plane direction determined by the alignment pattern of the liquid crystal layer 443 of the PBOE 44 due to diffraction, and this change does not depend on the incident angle. Therefore, the additivity of the diffraction of the PBOE 44 does not strictly hold true for the angles, but actually holds true for the changes in the in-plane direction components of the wave vector of circularly polarized light due to the diffraction.

In the example shown in FIG. 6, both of the two wave plates 43 are set in the voltage application state. In this case, when the beam Bin enters the first wave plate 43, the beam B1 of the left-handed circularly polarized light is emitted from the first wave plate 43 and enters the first PBOE 44. Then, the beam B2 of the right-handed circularly polarized light is emitted from the first PBOE 44 at a diffraction angle θ1 in the diffraction direction corresponding to the left-handed circularly polarized light (upward in FIG. 6), and enters the second wave plate 43.

Then, the beam B3 of the right-handed circularly polarized light is emitted from the second wave plate 43 and enters the second PBOE 44. Then, the beam Bout of the left-handed circularly polarized light is emitted from the second PBOE 44 at a diffraction angle θ2 in the diffraction direction corresponding to the right-handed circularly polarized light (downward in FIG. 6). Therefore, the beam Bout is emitted at a diffraction angle (θ1−θ2) with respect to the incident direction of the beam Bin. In the present example, the diffraction angle θ2 is larger than the diffraction angle θ1.

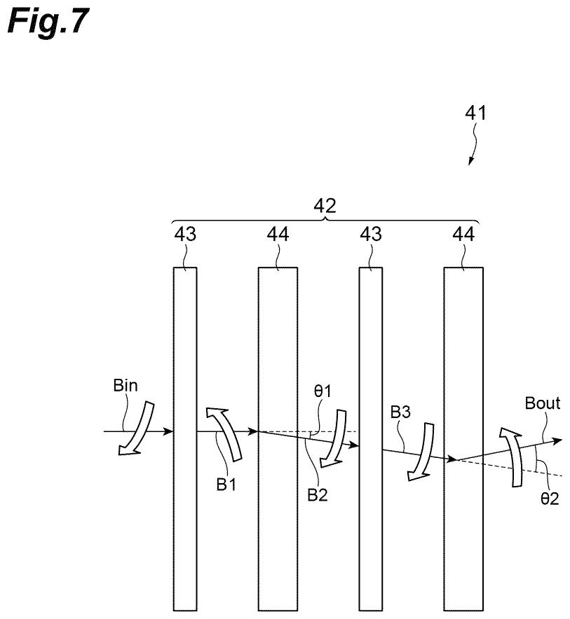

In the example shown in FIG. 7, the first wave plate 43 is set to the voltage non-application state and the second wave plate 43 is set to the voltage application state. In this case, when the beam Bin enters the first wave plate 43, the beam B1 of the right-handed circularly polarized light is emitted from the first wave plate 43 and enters the first PBOE 44. Then, the beam B2 of the left-handed circularly polarized light is emitted from the first PBOE 44 at the diffraction angle θ1 in the diffraction direction corresponding to the right-handed circularly polarized light (downward in FIG. 7), and enters the second wave plate 43.

Then, the beam B3 of the left-handed circularly polarized light is emitted from the second wave plate 43 and enters the second PBOE 44. Then, the beam Bout of the right-handed circularly polarized light is emitted from the second PBOE 44 at the diffraction angle θ2 in the diffraction direction corresponding to the left-handed circularly polarized light (upward in FIG. 7). Therefore, the beam Bout is emitted at a diffraction angle (θ2−θ1) with respect to the incident direction of the beam Bin.

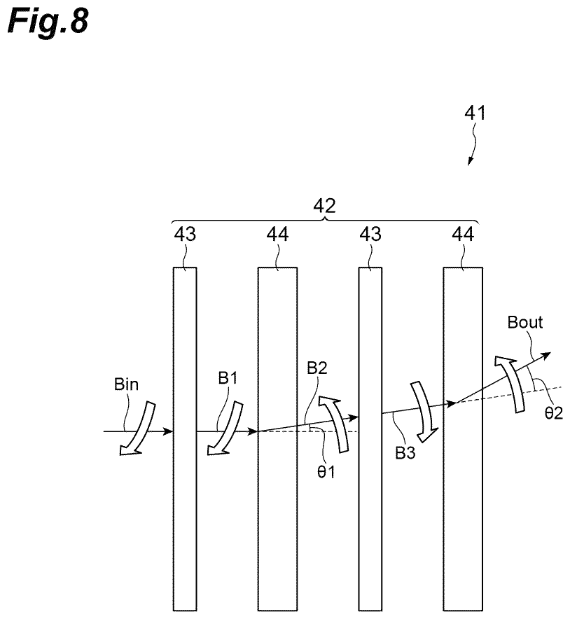

In the example shown in FIG. 8, the first wave plate 43 is set to the voltage application state, and the second wave plate 43 is set to the voltage non-application state. In this case, when the beam Bin enters the first wave plate 43, the beam B1 of the left-handed circularly polarized light is emitted from the first wave plate 43 and enters the first PBOE 44. Then, the beam B2 of the right-handed circularly polarized light is emitted from the first PBOE 44 at the diffraction angle θ1 in the diffraction direction corresponding to the left-handed circularly polarized light (upward in FIG. 8), and enters the second wave plate 43.

Then, the beam B3 of the left-handed circularly polarized light is emitted from the second wave plate 43 and enters the second PBOE 44. Then, the beam Bout of the right-handed circularly polarized light is emitted from the second PBOE 44 at the diffraction angle θ2 in the diffraction direction corresponding to the left-handed circularly polarized light. Therefore, the beam Bout is emitted at a diffraction angle (θ1+θ2) with respect to the incident direction of the beam Bin.

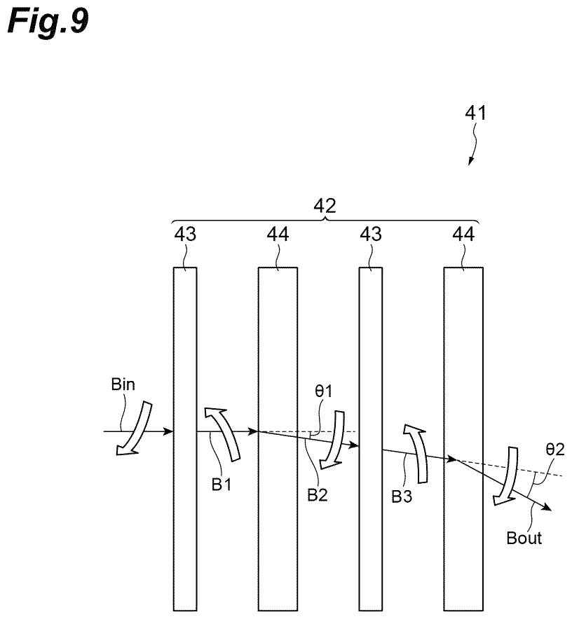

In the example shown in FIG. 9, both of the two wave plates 43 are set to the voltage non-application state. In this case, when the beam Bin enters the first wave plate 43, the beam B1 of the right-handed circularly polarized light is emitted from the first wave plate 43 and enters the first PBOE 44. Then, the beam B2 of the left-handed circularly polarized light is emitted from the first PBOE 44 at the diffraction angle θ1 in the diffraction direction corresponding to the right-handed circularly polarized light (downward in FIG. 9), and enters the second wave plate 43.

Then, the beam B3 of the right-handed circularly polarized light is emitted from the second wave plate 43 and enters the second PBOE 44. Then, the beam Bout of the left-handed circularly polarized light is emitted from the second PBOE 44 at the diffraction angle θ2 in the diffraction direction corresponding to the right-handed circularly polarized light. Therefore, the beam Bout is emitted at a diffraction angle (−θ1−θ2) with respect to the incident direction of the beam Bin.

As described above, by switching the state of each wave plate 43 between the voltage application state and the voltage non-application state, the traveling direction of the beam passing through the deflector 41 is changed. The traveling direction of the beam passing through the deflector 41 can be switched among 2ⁿ traveling directions in accordance with the number n of pairs of the wave plate 43 and the PBOE 44 included in the optical unit 4.

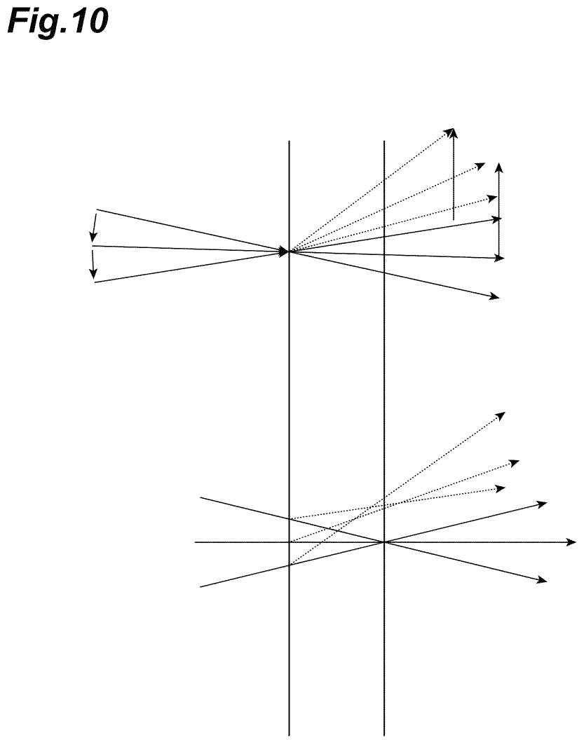

Next, the operation and effects of the retinal projection device 1 will be described with reference to FIG. 10. FIG. 10 is a diagram for explaining the change in wave vector due to deflection. As shown in FIG. 10, when deflection is performed at a position away from the focusing position P, focusing at a (virtual) focusing point generated when the deflected beam is extended back and forth in the traveling axis direction becomes incomplete, resulting in spherical aberration. This is because the optical system disposed in the subsequent stage is designed to finally convert the light diverging from the focusing point into the parallel light, and if the focusing is incomplete, the conversion to the parallel light is also incomplete. Here, this is referred to as “spherical aberration”. On the other hand, when deflection is performed at the focusing position P, spherical aberration is reduced.

In the retinal projection device 1 described above, the optical unit 4 including the deflector 41 is arranged so as to overlap the focusing position P, and the traveling direction of the beam by the deflector 41 is adjusted in accordance with the position of the pupil PP of the user. According to this configuration, even if the user moves the user's eye, the traveling direction of the beam can be changed following the movement of the pupil PP of the user. Since the deflector 41 is disposed in the vicinity of the focusing position P, spherical aberration caused by the change in the traveling direction of the beam (deflection) is reduced. Therefore, since the quality of imaging on the retina is maintained, the user can correctly recognize the image. As a result, the eye box can be expanded.

The polarity (polarization state) of the circularly polarized light passing through the wave plate 43 can be switched by switching the wave plate 43 between a state in which the polarization state of the circularly polarized light is preserved (voltage non-application state) and a state in which the circularly polarized light is converted into a circularly polarized light having an opposite polarity (voltage application state). In accordance with the polarity of the circularly polarized light, the diffraction direction in the PBOE 44 provided in the subsequent stage of the wave plate 43 is determined. Therefore, the traveling direction of the beam can be selected from a number of traveling directions corresponding to the number n of pairs of the wave plate 43 and the PBOE 44 included in the optical unit 4 by the voltage applied to each wave plate 43.

In the wave plate 43, the liquid crystal layer 437 is provided between the transparent substrate 431 and the transparent substrate 432. According to this configuration, an electric field is generated in the liquid crystal layer 437 by applying a voltage between the transparent substrate 431 and the transparent substrate 432, and the liquid crystal molecules Lm1 contained in the liquid crystal layer 437 are oriented in the direction of the electric field. Therefore, in a state where a voltage is applied between the transparent substrate 431 and the transparent substrate 432, the wave plate 43 preserves the polarization state of the circularly polarized light passing through the wave plate 43. In a state where no voltage is applied between the transparent substrate 431 and the transparent substrate 432, the liquid crystal molecules Lm1 contained in the liquid crystal layer 437 are in an in-plane orientation state. At this time, the wave plate 43 converts the circularly polarized light passing through the wave plate 43 into a circularly polarized light having an opposite polarity. In this way, depending on whether or not a voltage is applied between the transparent substrate 431 and the transparent substrate 432, it is possible to switch between a state in which the polarization state of the circularly polarized light is preserved and a state in which the circularly polarized light is converted into a circularly polarized light having an opposite polarity.

The PBOE 44 is made of a liquid crystal polymer. By using a liquid crystal polymer, the PBOE 44 can be easily formed.

The projector module 2 emits laser light obtained by multiplexing a red laser light, a green laser light and a blue laser light. Therefore, the full-color retinal projection device 1 can be realized.

In the examples shown in FIGS. 6 to 9, each PBOE 44 can diffract circularly polarized light in the X-axis direction. This configuration makes it possible to follow the change of the viewpoint in the X-axis direction. In order to follow the change of the viewpoint in the Y-axis direction, the deflector 41 may include a PBOE 44 capable of diffracting circularly polarized light in the Y-axis direction. The deflector 41 may include a PBOE 44 capable of diffracting circularly polarized light in the X-axis direction and a PBOE 44 capable of diffracting circularly polarized light in the Y-axis direction. In this case, two-dimensional beam steering in the XY plane is realized.

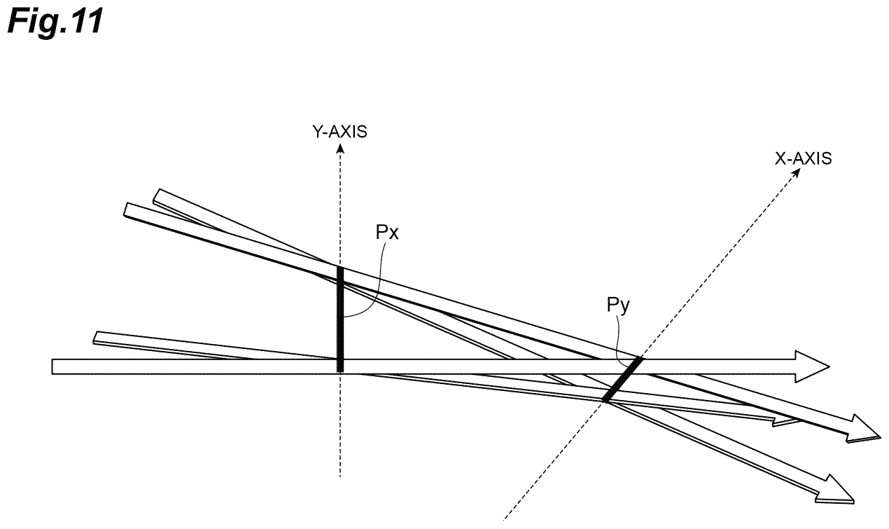

As shown in FIG. 11, when a Keplerian optical system having a magnification in the X-axis direction and a magnification in the Y-axis direction different from each other is used as the projection lens 3, any intermediate imaging plane is not formed. In this case, the focusing position Px at which the beam is focused in the X-axis direction is away from the focusing position Py at which the beam is focused in the Y-axis direction. The focusing position Px has a linear shape extending in the Y-axis direction. The focusing position Py has a linear shape extending in the X-axis direction.

As the position of the deflector 41 is farther from the focusing position, the wavefront aberration due to the deflection increases. Therefore, the deflector 41 capable of diffracting circularly polarized light in the X-axis direction may be provided at the focusing position Px, and the deflector 41 capable of diffracting circularly polarized light in the Y-axis direction may be provided at the focusing position Py. In other words, the optical unit 4 may include a deflector 41 which is provided at the focusing position Px and capable of diffracting circularly polarized light in the X-axis direction, and a deflector 41 which is provided at the focusing position Py and capable of diffracting circularly polarized light in the Y-axis direction. According to this configuration, the position of the deflector 41 capable of diffracting circularly polarized light in the X-axis direction is brought closer to the focusing position Px, and the position of the deflector 41 capable of diffracting circularly polarized light in the Y-axis direction is brought closer to the focusing position Py. Therefore, it is possible to suppress the wavefront aberration due to the deflection, so that the cost required for correcting the aberration can be reduced.

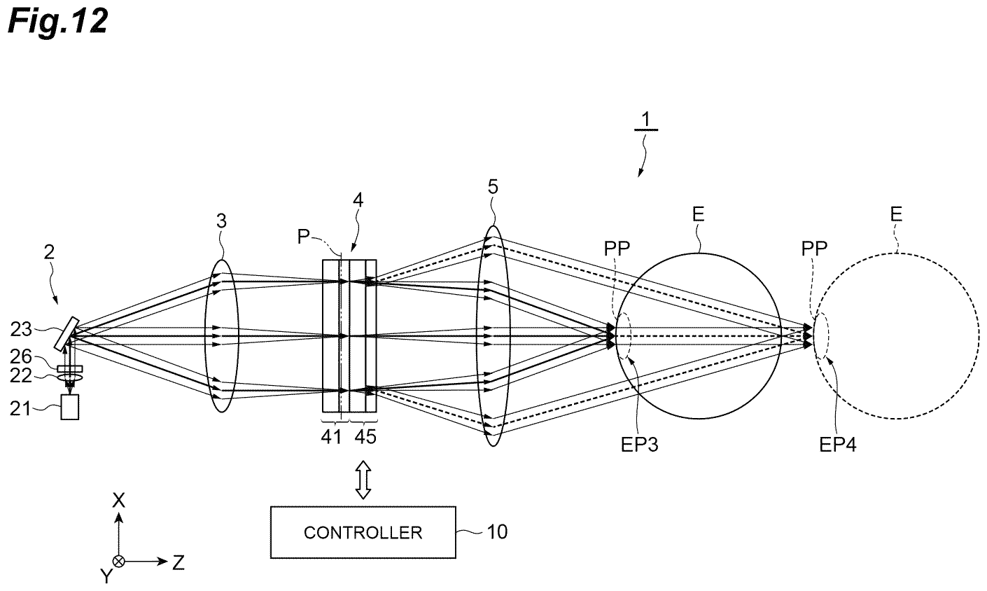

Next, a configuration capable of following a change of viewpoint in the Z-axis direction (front-rear direction) will be described with reference to FIG. 12. FIG. 12 is a diagram showing a basic configuration of a retinal projection device according to a modified example. As shown in FIG. 12, the retinal projection device 1 according to the modified example is mainly different from the retinal projection device 1 according to the above-described embodiment in that the optical unit 4 further includes a deflector 45.

The deflector 45 is mainly different from the deflector 41 in that the deflector 45 includes a PBOE 44 that functions as a concave and convex lens instead of a PBOE 44 that functions as a diffraction grating that diffracts at a constant diffraction angle. As a method for determining the orientation of the liquid crystal molecules Lm2 for realizing the PBOE 44, for example, the following method is used.

Generally, the lens function corresponds to the phase shift amount between before and after the passage of the light ray at each in-plane position. On the other hand, in the PBOE 44, the rotation direction of the electric field vector is reversed by reversing the polarity of the circularly polarized light due to the transmission of the light ray. Specifically, an electric field vector obtained by reflecting the electric field vector of incident circularly polarized light with respect to the axis perpendicular to the slow axis determined by the orientation direction of the liquid crystal molecules Lm2 becomes an electric field vector of the circularly polarized light having an opposite polarity converted by the PBOE 44. Therefore, the change amount in the in-plane direction of the phase shift amount between before and after the passage of the light ray at each in-plane position is equal to −2 times the amount of rotation in the in-plane direction of the orientation azimuth angles of the liquid crystal molecules Lm2 (assuming that the polarity of the rotation direction of the electric field vector of the incident circularly polarized light is positive). Therefore, by arbitrarily determining the orientation direction of the liquid crystal molecule Lm2 at a certain point, the orientation directions of the liquid crystal molecules Lm2 at other points are necessarily determined by the required lens function. According to this concept, for example, the PBOE that functions as a convex lens when the incident light is the right-handed circularly polarized light is designed to have a configuration in which the orientation azimuth angles of the liquid crystal molecules Lm2 rotate rightward from the center toward the periphery when viewed from the incident surface.

The PBOE 44 functions as a convex lens for the right-handed circularly polarized light and a concave lens for the left-handed circularly polarized light, for example. By configuring the plurality of PBOEs 44 included in the deflector 45 so as to have focal lengths different from each other, it is possible to correspond to the positions of the plurality of viewpoints in the Z-axis direction. In FIG. 12, a position EP3 and a position EP4 are exemplified as the position of the pupil PP.

In the retinal projection device 1 according to the modified example, the same effects as those of the retinal projection device 1 according to the above-described embodiment can be obtained in the configuration common to the retinal projection device 1 according to the above-described embodiment. In the retinal projection device 1 according to the modified example, since the optical unit 4 includes the deflector 45, it is possible to follow the change of the viewpoint in the Z-axis direction. That is, even if the distance between the optical device 5 and the pupil PP of the user fluctuates, the field of view can be secured. For example, when the retinal projection device 1 is applied to a near-eye display such as smart glasses, a misalignment of the near-eye display is acceptable.

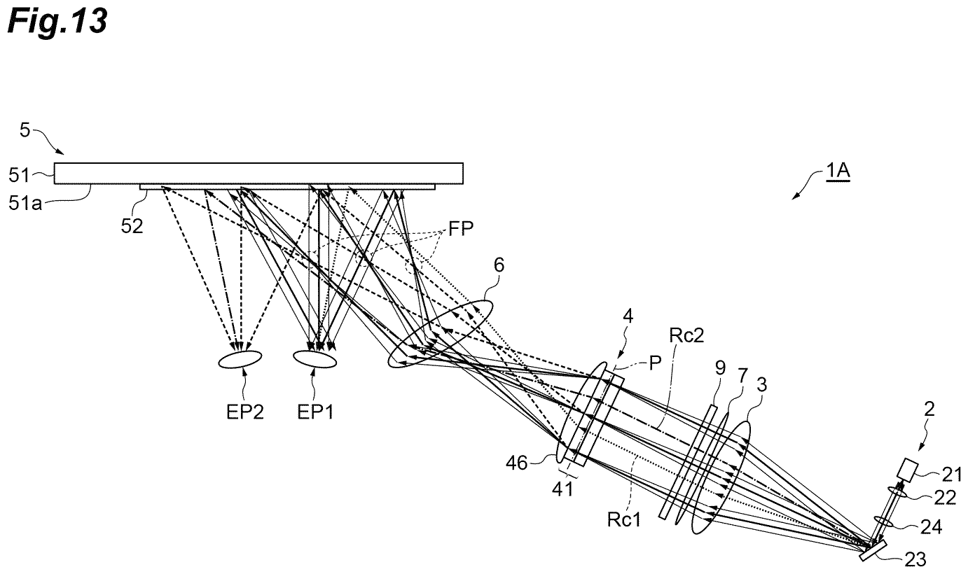

Next, an application example of the retinal projection device will be described with reference to FIG. 13. FIG. 13 is a diagram showing an application example of the retinal projection device shown in FIG. 1. A retinal projection device 1A shown in FIG. 13 may be applied to a near-eye display such as smart glasses. In FIG. 13, the controller 10 is not shown.

In the retinal projection device 1A, the optical device 5 is a combiner. The optical device 5 includes a transparent substrate 51 and a reflector 52. The transparent substrate 51 is a substrate having a visible light transmission property which transmits visible light. Examples of constituent materials of the transparent substrate 51 include SiO₂, optical glass, and optical plastic. The transparent substrate 51 has a surface 51a facing the eyeball E of the user wearing the near-eye display. The transparent substrate 51 may be a lens of smart glasses. The reflector 52 is provided on the surface 51a and functions as a translucent concave mirror. The reflector 52 is, for example, a reflective diffraction grating layer such as a polarization volume grating (PVG).

The projector module 2 further includes a wavefront correction lens 24 (wavefront correction unit). The wavefront correction lens 24 is a lens for correcting a wavefront aberration of the light ray (a light ray corresponding to the center of the field of view) passing through the pupil PP among light rays constituting the beams. The wavefront correction lens 24 corrects, for example, three or more orders of aberration. The wavefront correction lens 24 is provided between the collimation lens 22 and the movable mirror 23. The wavefront correction lens 24 is provided, for example, in front of the movable mirror 23. The wavefront correction lens 24 is constituted by a liquid crystal lens.

In the wavefront correction lens 24, the region through which the light ray Rc1 passes and the region through which the light ray Rc2 passes are close to each other. The light ray Rc1 is a light ray corresponding to the center of the field of view when the pupil PP is located at the position EP1. The light ray Rc2 is a light ray corresponding to the center of the field of view when the pupil PP is located at the position EP2. Therefore, the wavefront correction lens 24 adaptively corrects the wavefront aberration in accordance with the position of the pupil PP. Specifically, the controller 10 (see FIG. 1) controls the wavefront correction lens 24 in accordance with the position of the pupil PP of the user so that the wavefront error of the beam constituting the pixel on the line of sight, that is, in the gaze direction among the beams passing through the pupil PP is minimized.

The optical unit 4 further includes a field lens 46. The field lens 46 is a lens for changing the traveling direction of the light ray near the focal point of the beam. The field lens 46 is provided at the second end 42b (output end) of the array 42. Specifically, the field lens 46 is provided so as to cover the PBOE 44 located at the second end 42b.

The retinal projection device 1A further includes a wave plate 9 (first wave plate) instead of the wave plate 26. The wave plate 9 is an optical element for converting linearly polarized light into circularly polarized light. The wave plate 9 is disposed between the laser module 21 and the optical unit 4. When an element assuming operation with linearly polarized light is disposed between the laser module 21 and the optical unit 4, the wave plate 9 is disposed in the subsequent stage of the element assuming operation with linearly polarized light. As the wave plate 9, a true quarter-wave plate is used in consideration of wavelength dispersion and the like, but a ¼+N (N is a natural number) wave plate may be used.

The retinal projection device 1A further includes a relay lens 6 (focusing area) and a wavefront correction lens 7 (wavefront correction unit). The relay lens 6 is a lens for focusing the beam emitted from the optical unit 4. The relay lens 6 is provided between the optical unit 4 and the optical device 5. The relay lens 6 is constituted by a convex lens or a lens group that functions as a convex lens.

The wavefront correction lens 7 is a lens that mainly corrects the fluctuation caused by switching of the deflector 41 in the field angle dependence of the focal point of the beam, that is, the field angle dependence of the diopter of the retina. The wavefront correction lens 7 is provided between the projection lens 3 and the optical unit 4. The wavefront correction lens 7 is provided, for example, immediately after the projection lens 3. The wavefront correction lens 7 may be provided immediately before the projection lens 3. The wavefront correction lens 7 is constituted by a liquid crystal lens.

In the example shown in FIG. 13, the wavefront aberration of each of the light rays Rc1 and Rc2 is corrected. The wavefront correction lens 7, like the wavefront correction lens 24, is configured to adaptively correct wavefront aberration in accordance with the position of the pupil PP.

Also in the retinal projection device 1A, the same effects as those of the retinal projection device 1 can be obtained in the configuration common to the retinal projection device 1. The retinal projection device 1A further includes the wavefront correction lens 7 and the wavefront correction lens 24. Therefore, the resolution at the center of the field of view can be improved. The wavefront correction lens 7 and the wavefront correction lens 24 are constituted by liquid crystal lenses. By using the liquid crystal lens, the wavefront correction lens 7 and the wavefront correction lens 24 can be easily realized. When a liquid crystal lens is used, most liquid crystal lenses function not for circularly polarized light but for linearly polarized light, so that a wave plate for converting linearly polarized light into circularly polarized light is disposed between the liquid crystal lens and the optical unit 4.

The wavefront correction lens 7 mainly corrects the fluctuation caused by switching of the deflector 41 in the field angle dependence of the focal point of the beam, that is, the field angle dependence of the diopter of the retina. The function of the wavefront correction lens 7 is to correct the change of the imaging position (front or back of the retina) on the retina depending on the incident angle on the pupil PP, and this change is caused by the fluctuation of the aberration of the optical system included in the retinal projection device 1A due to the switching of the deflector 41 or by the aberration of the naked eye. In particular, even in the case of myopia in which the axis of the eye extends and the focal point of the naked eye is easily shifted to the back side of the retina around the field of view with respect to the center of the field of view, the wavefront correction lens 7 can perform the correction. This correction can also be performed with fixed-function lenses such as normal progressive power glasses, but if the line of sight moves up, down, left, or right, the correction becomes inappropriate, so that the effect of the correction is small. On the other hand, by using a variable lens such as a liquid crystal lens, the wavefront correction lens 7 can perform the correction in accordance with the movement of the line of sight.

The variable wavefront correction lens 24 is provided between the collimation lens 22 and the movable mirror 23. As shown in FIG. 13, this makes it possible to effectively correct the third or higher order aberration caused when the beam is obliquely incident on the optical element such as the combiner 5. Although the aberration depends on the angle and position of the beam, the wavefront correction function of the wavefront correction lens 24 may be set so as to provide the best correction for the beam at the angle and position coincident with the line of sight at the time of incidence on the pupil PP. In this case, since the resolution outside a very narrow range around the line of sight is low for the naked eye, there is no practical problem. Therefore, the controller 10 detects the position and angle of the pupil PP, controls the beam so as to reach the position of the pupil PP by deflection by the optical unit 4, and controls the center of the field of view of the naked eye to maintain a high resolution by the wavefront correction lens 24.

The retinal projection device 1A includes the wavefront correction lens 7 and the wavefront correction lens 24, and the wavefront correction lens 7 and the wavefront correction lens 24 share functions. In addition, the controller 10 controls the wavefront correction lens 24 so that the best correction is applied to the beam forming the pixel at the center of the field of view of the naked eye, i.e., at a gaze point on the retina. As long as the wavefront correction lens 24 can operate at a frequency that allows the wavefront correction lens 24 to follow the operating frequency of the movable mirror 23, it is possible to apply the wavefront correction to all the beams completely, and it is also possible to perform the focusing for each beam. In this case, since the wavefront correction lens 24 can also include the function of the wavefront correction lens 7, the wavefront correction lens 7 can be omitted.

The wavefront correction lens 7 may be provided immediately before or after the relay lens 6 in the subsequent stage of the deflector 41, as long as the spatial separation of the beams with different angles of view is well maintained at the position of the wavefront correction lens 7. In this case, an element (wave plate) for converting the circularly polarized light from the deflector 41 into an appropriate linearly polarized light is provided in the preceding stage. When the wavefront correction lens 7 is provided in the subsequent stage of the deflector 41, the wave plate 9 may be provided between the wavefront correction lens 24 and the optical unit 4, or may be provided immediately after the collimation lens 22.

The focal point FP of the optical device 5 is located in front of the optical device 5. Therefore, when the relay lens 6 is not provided, it is necessary to place the optical unit 4 at the focal point FP. In this case, there is a risk that the optical unit 4 may block the user's field of view. On the other hand, in the retinal projection device 1A, the relay lens 6 is provided between the optical unit 4 and the optical device 5. With this configuration, the optical unit 4 can be provided at a position away from the optical device 5. Therefore, the degree of freedom in the arrangement of the optical unit 4 can be improved, and the user's field of view can be secured.

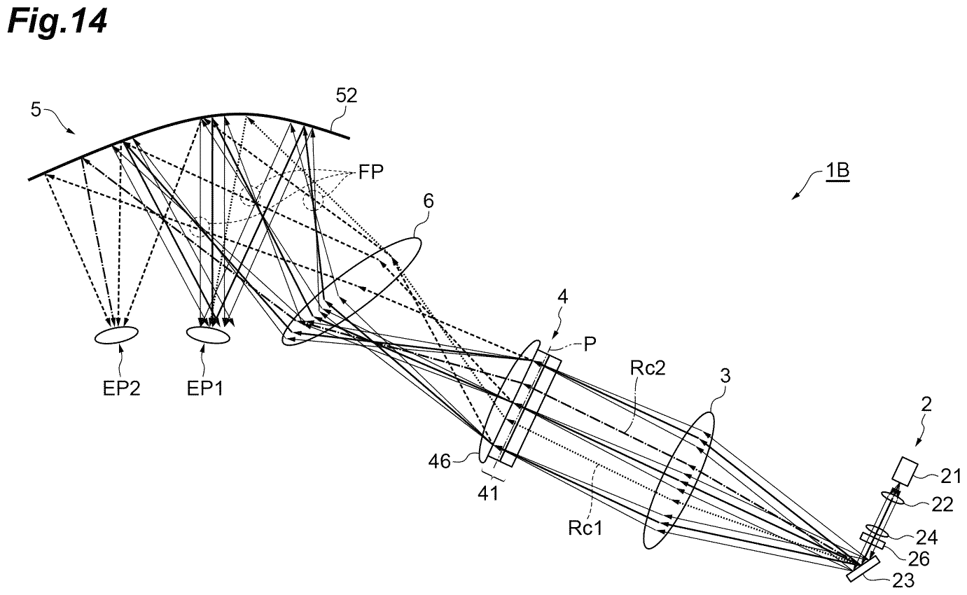

Next, another application example of the retinal projection device will be described with reference to FIG. 14. FIG. 14 is a diagram showing another application example of the retinal projection device shown in FIG. 1. A retinal projection device 1B shown in FIG. 14 is mainly different from the retinal projection device 1A in that the reflector 52 is a concave mirror instead of the reflective diffraction grating layer, the retinal projection device 1B does not include the wavefront correction lens 7, and the projector module 2 includes the wave plate 26 instead of the wave plate 9. The retinal projection device 1B may be applied to a near-eye display such as smart glasses. In FIG. 14, the controller 10 is not shown.

Also in the retinal projection device 1B, the same effects as those of the retinal projection device 1A can be obtained in the configuration common to the retinal projection device 1A. In the retinal projection device 1B, the reflector 52 is a concave mirror. The concave mirror has less fluctuation in focus due to switching of the deflector 41 than the holographic combiner. In the retinal projection device 1B, the projector module 2 includes the wavefront correction lens 24. Since the wavefront correction lens 24 adaptively corrects the wavefront aberration in accordance with the position of the pupil PP, the resolution at the center of the field of view can be further improved. The wavefront correction lens 24 is constituted by a liquid crystal lens. By using the liquid crystal lens, the wavefront correction lens 24 can be easily realized.

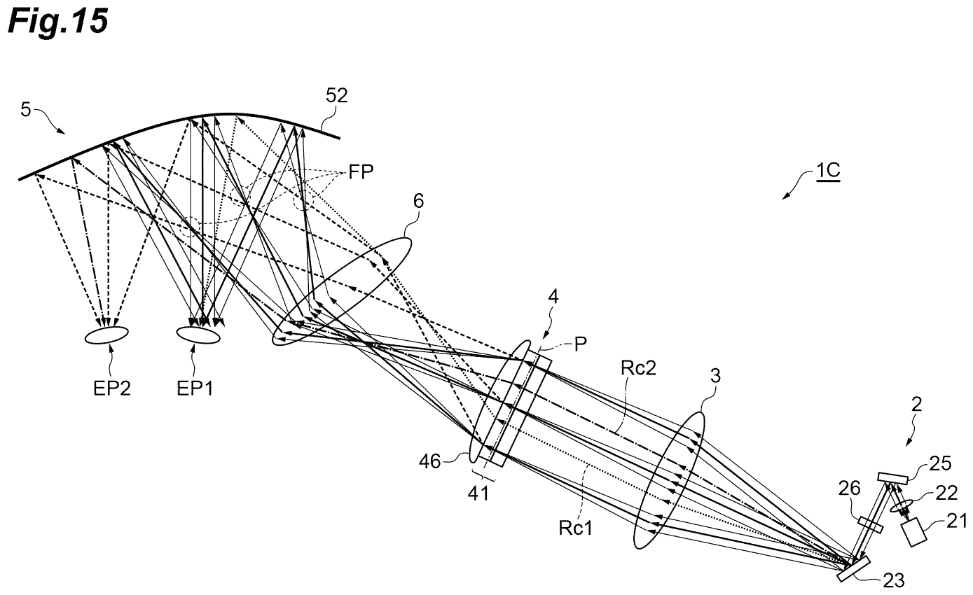

Next, yet another application example of the retinal projection device will be described with reference to FIG. 15. FIG. 15 is a diagram showing yet another application example of the retinal projection device shown in FIG. 1. A retinal projection device 1C shown in FIG. 15 is mainly different from the retinal projection device 1B in that the projector module 2 includes a reflective wavefront correction element 25 (wavefront correction unit) instead of the wavefront correction lens 24. The retinal projection device 1C may be applied to a near-eye display such as smart glasses. In FIG. 15, the controller 10 is not shown.

The wavefront correction element 25 is an optical element for correcting the wavefront aberration of the light ray (the light ray corresponding to the center of the field of view) passing through the pupil PP among the light rays constituting the beams. The wavefront correction element 25 corrects, for example, third or higher order aberration. The wavefront correction element 25 reflects the beam emitted from the collimation lens 22 to apply the beam onto the movable mirror 23. The wavefront correction element 25 is constituted by, for example, a deformable mirror. Examples of the deformable mirror include a MEMS type deformable mirror and a piezoelectric deformable mirror. The wavefront correction element 25 may be constituted by an LCOS.

Also in the retinal projection device 1C, the same effects as those of the retinal projection device 1B can be obtained in the configuration common to the retinal projection device 1B. In the retinal projection device 1C, the projector module 2 includes the wavefront correction element 25. Since the wavefront correction element 25 adaptively corrects the wavefront aberration in accordance with the position of the pupil PP, the resolution at the center of the field of view can be further improved. The wavefront correction element 25 is constituted by a deformable mirror or an LCOS. By using the deformable mirror or the LCOS, the wavefront correction element 25 can be easily realized.

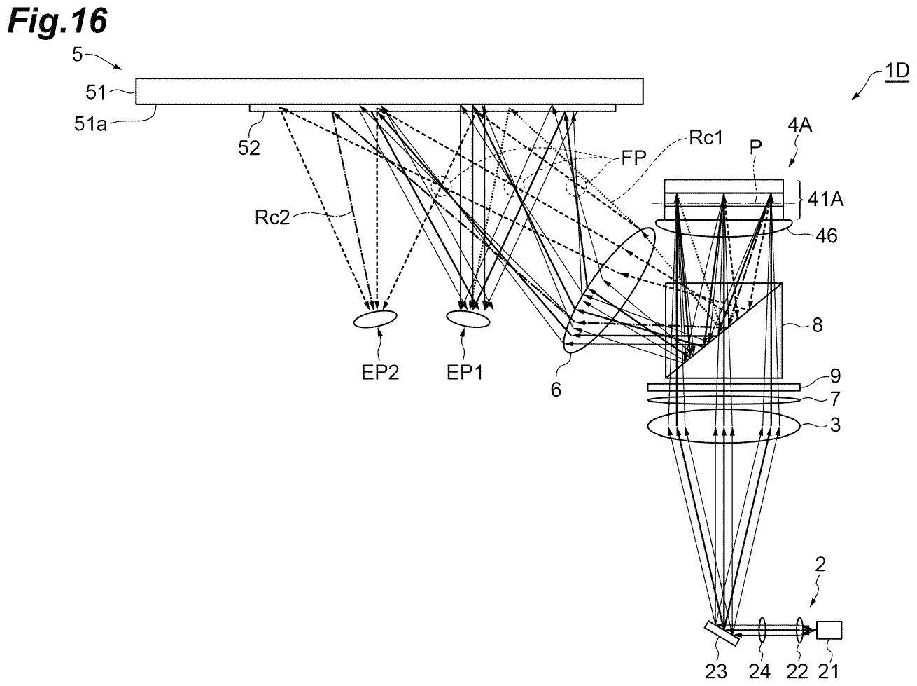

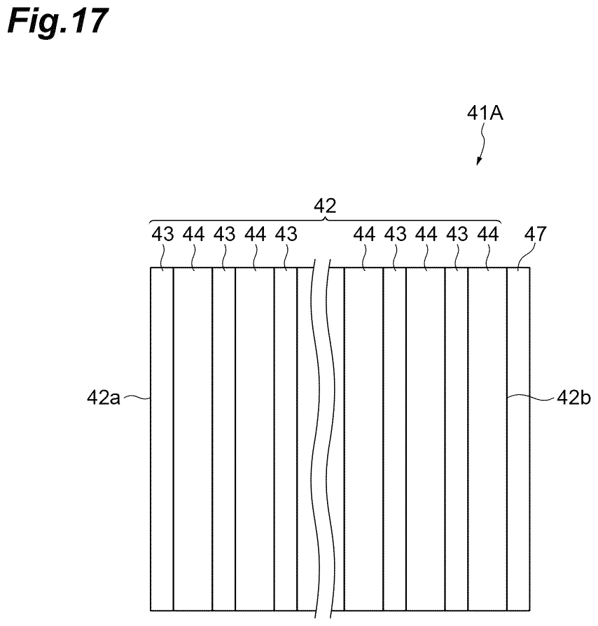

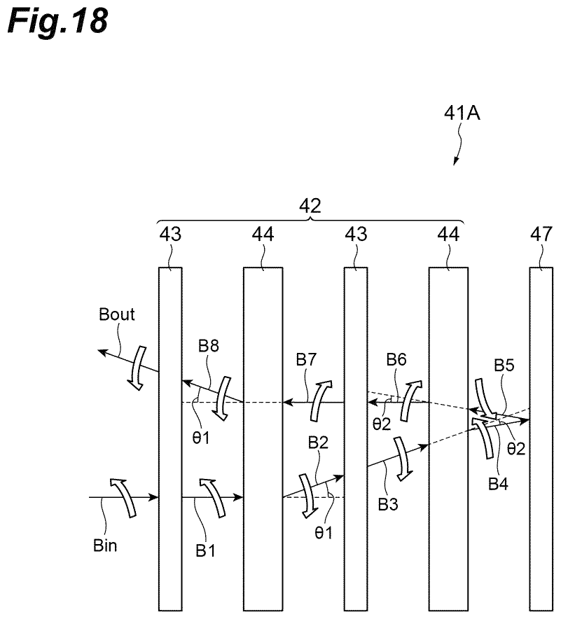

Next, yet another application example of the retinal projection device will be described with reference to FIGS. 16 to 18. FIG. 16 is a diagram showing yet another application example of the retinal projection device shown in FIG. 1. FIG. 17 is a diagram schematically showing the configuration of the deflector shown in FIG. 16. FIG. 18 is a diagram for explaining the operation of the deflector shown in FIG. 16. A retinal projection device 1D shown in FIG. 16 is mainly different from the retinal projection device 1A in that the retinal projection device 1D includes an optical unit 4A instead of the optical unit 4 and further includes a beam splitter 8. The retinal projection device 1D may be applied to a near-eye display such as smart glasses. In FIG. 16, the controller 10 is not shown.

The beam splitter 8 is provided between the projection lens 3 and the optical unit 4A. The beam splitter 8 is, for example, a half mirror beam splitter. The beam splitter 8 transmits the beam emitted from the projection lens 3 and reflects the beam emitted from the optical unit 4A. The optical unit 4A is mainly different from the optical unit 4 in that the optical unit 4A includes a deflector 41A instead of the deflector 41 and in the arrangement of the field lens 46. The field lens 46 is provided at the first end 42a. Specifically, the field lens 46 is provided so as to cover the wave plate 43 located at the first end 42a. The deflector 41A is a reflective deflector.

As shown in FIG. 17, the deflector 41A is mainly different from the deflector 41 in that the deflector 41A further includes a reflector 47. The reflector 47 is an optical element that reflects circularly polarized light while preserving (maintaining) the polarity of the circularly polarized light. The reflector 47 is referred to as a handedness preserving mirror (HPM). The reflector 47 is provided at the second end 42b (one end) of the array 42. Specifically, the reflector 47 is superimposed on the PBOE 44 located at the second end 42b. An example of the reflector 47 is a polarization preserving anisotropic mirror (PPAM). The PPAM is formed by alternately laminating a plurality of films having an in-plane birefringence index and having a thickness of approximately quarter-wavelength with the slow axes orthogonal to each other. The reflector 47 may be formed by superimposing a quarter-wave plate on the mirror surface of an ordinary mirror.

The beam steering (beam deflection) by the deflector 41A will be described with reference to FIG. 18. Here, for convenience of description, a case where the deflector 41A includes two wave plates 43 and two PBOEs 44 and the beam Bin of the right-handed circularly polarized light enters the deflector 41A will be exemplified. In the example shown in FIG. 18, both of the two wave plates 43 are set in the voltage application state.

In this case, when the beam Bin enters the first wave plate 43, the beam B1 of the right-handed circularly polarized light is emitted from the first wave plate 43 and enters the first PBOE 44. Then, the beam B2 of the left-handed circularly polarized light is emitted from the first PBOE 44 at the diffraction angle θ1 in the diffraction direction corresponding to the right-handed circularly polarized light (upward in FIG. 18) and enters the second wave plate 43. Then, the beam B3 of the left-handed circularly polarized light is emitted from the second wave plate 43 and enters the second PBOE 44. Then, the beam B4 of the right-handed circularly polarized light is emitted from the second PBOE 44 at the diffraction angle θ2 in the diffraction direction corresponding to the left-handed circularly polarized light (downward in FIG. 18).

Then, the beam B4 is reflected by the reflector 47 while maintaining the polarization state, and is emitted from the reflector 47 as the beam B5 and enters the second PBOE 44. Then, the beam B6 of the left-handed circularly polarized light is emitted from the second PBOE 44 at the diffraction angle θ2 in the diffraction direction corresponding to the right-handed circularly polarized light (downward in FIG. 18) and enters the second wave plate 43. Then, the beam B7 of the left-handed circularly polarized light is emitted from the second wave plate 43 and enters the first PBOE 44. Then, the beam B8 of the right-handed circularly polarized light is emitted from the first PBOE 44 at the diffraction angle θ1 in the diffraction direction corresponding to the left-handed circularly polarized light (upward in FIG. 18) and enters the first wave plate 43. Then, the beam Bout of the right-handed circularly polarized light is emitted from the first wave plate 43.

Therefore, the beam Bout is emitted at a diffraction angle (2×θ1−2×θ2) with respect to the direction in which the incident direction of the beam Bin is inverted. In the present example, the diffraction angle θ1 is larger than the diffraction angle θ2. As described above, in the deflector 41A, the beam passes through the same PBOE 44 twice. Therefore, the change amount in the wave vector due to the deflector 41A is twice as large as the change amount in the wave vector due to the deflector 41.

In the above description, it is assumed that the diffraction angle of the PBOE 44 does not depend on the incident angle on the PBOE 44. This assumption holds as a good approximation when the diffraction angle of the PBOE 44 is small. Actually, in the PBOE 44, the in-plane direction components of the wave vector of the incident light are changed by an intrinsic wave vector in the in-plane direction determined by the alignment pattern of the liquid crystal layer 443 of the PBOE 44 due to diffraction, and this change does not depend on the incident angle. Therefore, the additivity of the diffraction of the PBOE 44 does not strictly hold true for the angles, but actually holds true for the changes in the in-plane direction components of the wave vector of circularly polarized light due to the diffraction. That is, to be precise, in the reflective deflector 41A described above, the change amount in the in-plane direction components of the wave vector is doubled.

In the retinal projection device 1D, the beam emitted from the projection lens 3 passes through the beam splitter 8, enters the optical unit 4A, and is deflected in the optical unit 4A. The beam emitted from the optical unit 4A is reflected by the beam splitter 8 and enters the optical device 5 via the relay lens 6.

When the deflector 41A is disposed near the intermediate imaging plane, the PBOE 44 near the intermediate imaging plane among the PBOEs 44 included in the deflector 41A may be configured to have a function of a field lens. In this case, the optical unit 4A may not include the field lens 46.

Also in the retinal projection device 1D, the same effects as those of the retinal projection device 1A can be obtained in the configuration common to the retinal projection device 1A. When a reflector that inverts circularly polarized light is provided at the second end 42b, the deflection obtained when the beam passes through the array 42 from the first end 42a toward the second end 42b is cancelled by the deflection obtained when the beam passes through the array 42 from the second end 42b toward the first end 42a. On the other hand, in the retinal projection device 1D, the reflector 47 that reflects circularly polarized light while preserving the polarity of the circularly polarized light is provided at the second end 42b of the array 42.

According to this configuration, the beam that has passed through the array 42 from the first end 42a toward the second end 42b is reflected by the reflector 47 while maintaining the polarization state, and passes through the array 42 again from the second end 42b toward the first end 42a. In the deflector 41A, since the beam in the same polarization state passes through the same PBOE 44 twice, the change amount in the in-plane direction components of the wave vector by the deflector 41A is twice as large as the change amount in the in-plane direction components of the wave vector by the deflector 41.

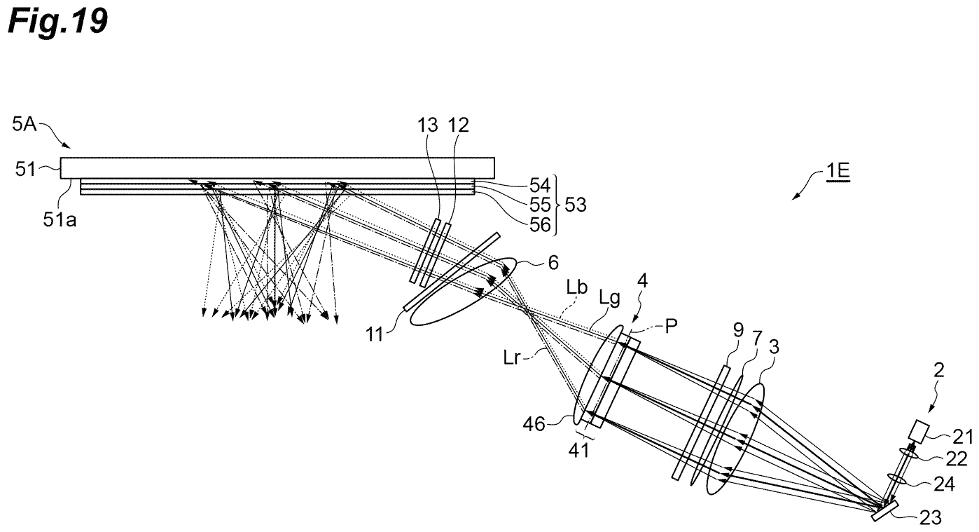

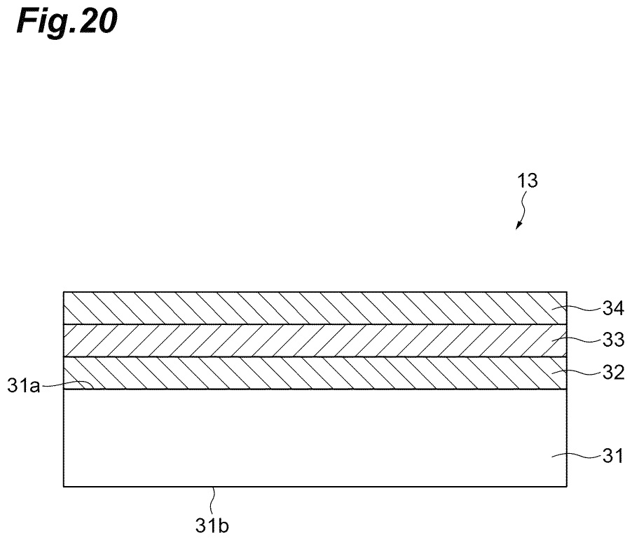

Next, yet another application example of the retinal projection device will be described with reference to FIGS. 19 and 20. FIG. 19 is a diagram showing yet another application example of the retinal projection device shown in FIG. 1. FIG. 20 is a diagram schematically showing the configuration of the notch filter shown in FIG. 19. A retinal projection device 1E shown in FIG. 19 is mainly different from the retinal projection device 1A in that the retinal projection device 1E includes an optical device 5A instead of the optical device 5 and further includes a neutral density filter 11, a wave plate 12 and a notch filter 13. The retinal projection device 1E may be applied to a near-eye display such as smart glasses. In FIG. 19, the controller 10 is not shown.

The neutral density filter 11 is a filter for attenuating light reflected by the notch filter 13. Stray light can be reduced by the neutral density filter 11. The wave plate 12 is an optical element for converting the polarization state of the beam emitted from the optical unit 4 from circularly polarized light to linearly polarized light. The wave plate 12 is, for example, a quarter-wave plate. Instead of the wave plate 12, an absorption-type linear polarizer may be used.

The notch filter 13 is a circularly polarized light-dependent notch filter for removing an unnecessary circularly polarized light component from each of light having a red wavelength (hereinafter also referred to as “red light Lr”), light having a green wavelength (hereinafter also referred to as “green light Lg”), and light having a blue wavelength (hereinafter also referred to as “blue light Lb”) to extract a desired circularly polarized light component. The notch filter 13 has a function of passing the left-handed circularly polarized light in the red light Lr, reflecting the right-handed circularly polarized light in the red light Lr, passing the right-handed circularly polarized light in the green light Lg, reflecting the left-handed circularly polarized light in the green light Lg, passing the left-handed circularly polarized light in the blue light Lb, and reflecting the right-handed circularly polarized light in the blue light Lb.

As shown in FIG. 20, the notch filter 13 includes a transparent substrate 31, a filter layer 32 (third filter layer), a filter layer 33 (second filter layer), and a filter layer 34 (first filter layer).

The transparent substrate 31 is a substrate having a visible light transmission property which transmits visible light. The transparent substrate 31 is made of a constituent material having a low birefringence. Examples of the constituent material of the transparent substrate 31 include SiO₂, optical glass, and a glass substrate for a liquid crystal display. The transparent substrate 31 has a surface 31a and a surface 31b. The surface 31b is a surface opposite to the surface 31a.

The filter layer 32 is a layer that removes the right-handed circularly polarized light from the blue light Lb by reflecting the right-handed circularly polarized light, to extract the left-handed circularly polarized light. The filter layer 32 is provided on the surface 31a. The filter layer 32 is a cholesteric liquid crystal polymer layer, and is PVG. The cholesteric liquid crystal polymer layer of the filter layer 32 has a helical structure having a helical pitch corresponding to the blue wavelength and twisted in a twisting direction capable of reflecting the right-handed circularly polarized light. It is desirable that the direction of the helical axis is parallel to the direction of the central light ray of the beam arriving at the center of the field of view and at the center of the pupil PP when the line of sight when the line of sight faces the front. It should be noted that the “direction of the helical axis” means a direction in which the helical axis extends, and is referred to as a “helical axis direction” in the following description. The “twisting direction” refers to the direction of twisting in the sense of right-hand or left-hand screws.

The filter layer 33 is a layer that removes the left-handed circularly polarized light from the green light Lg by reflecting the left-handed circularly polarized light, to extract the right-handed circularly polarized light. The filter layer 33 is provided on the filter layer 32. The filter layer 33 is a cholesteric liquid crystal polymer layer, and is PVG. The cholesteric liquid crystal polymer layer of the filter layer 33 has a helical structure having a helical pitch corresponding to the green wavelength and twisted in a twisting direction capable of reflecting the left-handed circularly polarized light.

The filter layer 34 is a layer that removes the right-handed circularly polarized light from the red light Lr by reflecting the right-handed circularly polarized light, to extract the left-handed circularly polarized light. The filter layer 34 is provided on the filter layer 33. The filter layer 34 is a cholesteric liquid crystal polymer layer, and is PVG. The cholesteric liquid crystal polymer layer of the filter layer 34 has a helical structure having a helical pitch corresponding to the red wavelength and twisted in a twisting direction capable of reflecting the right-handed circularly polarized light.

The optical devices 5A is a holographic combiner. In the present embodiment, the optical device 5A has a function of scattering the left-handed circularly polarized light in a wavelength range including the red wavelength (first wavelength range), scattering the right-handed circularly polarized light in a wavelength range including the green wavelength (second wavelength range), and scattering the left-handed circularly polarized light in a wavelength range including the blue wavelength (third wavelength range). The optical device 5A is mainly different from the optical device 5 in that the optical device 5A includes a reflector 53 instead of the reflector 52.

Similar to the reflector 52, the reflector 53 is provided on the surface 51a and functions as a translucent concave mirror. The reflector 53 includes a holographic diffraction layer 54 (third holographic diffraction layer), a holographic diffraction layer 55 (second holographic diffraction layer), and a holographic diffraction layer 56 (first holographic diffraction layer).

The holographic diffraction layer 54 is a reflective diffraction grating layer that scatters (reflects) the left-handed circularly polarized light in a wavelength range including the blue wavelength. The holographic diffraction layer 54 does not scatter the right-handed circularly polarized light in the above-described wavelength range. The holographic diffraction layer 54 is constituted by a cholesteric liquid crystal polymer layer having a helical structure which has a helical pitch corresponding to the blue wavelength and is twisted in a twisting direction capable of reflecting the left-handed circularly polarized light.

The holographic diffraction layer 55 is a reflective diffraction grating layer that scatters (reflects) the right-handed circularly polarized light in a wavelength range including the green wavelength. The holographic diffraction layer 55 is laminated on the holographic diffraction layer 54. The holographic diffraction layer 55 does not scatter the left-handed circularly polarized light in the above-described wavelength range. The holographic diffraction layer 55 is constituted by a cholesteric liquid crystal polymer layer having a helical structure which has a helical pitch corresponding to the green wavelength and is twisted in a twisting direction capable of reflecting the right-handed circularly polarized light.

The holographic diffraction layer 56 is a reflective diffraction grating layer that scatters (reflects) the left-handed circularly polarized light in a wavelength range including the red wavelength. The holographic diffraction layer 56 does not scatter the right-handed circularly polarized light in the above-described wavelength range. The holographic diffraction layer 56 is constituted by a cholesteric liquid crystal polymer layer having a helical structure which has a helical pitch corresponding to the red wavelength and is twisted in a twisting direction capable of reflecting the left-handed circularly polarized light.

The holographic diffraction layer 54, the holographic diffraction layer 55, and the holographic diffraction layer 56 are laminated on the surface 51a in this order. Specifically, the holographic diffraction layer 54 is provided on the surface 51a. The holographic diffraction layer 55 is laminated on the holographic diffraction layer 54. The holographic diffraction layer 56 is laminated on the holographic diffraction layer 55. It should be noted that the laminating order of the holographic diffraction layer 54, the holographic diffraction layer 55, and the holographic diffraction layer 56 may be changed arbitrarily.

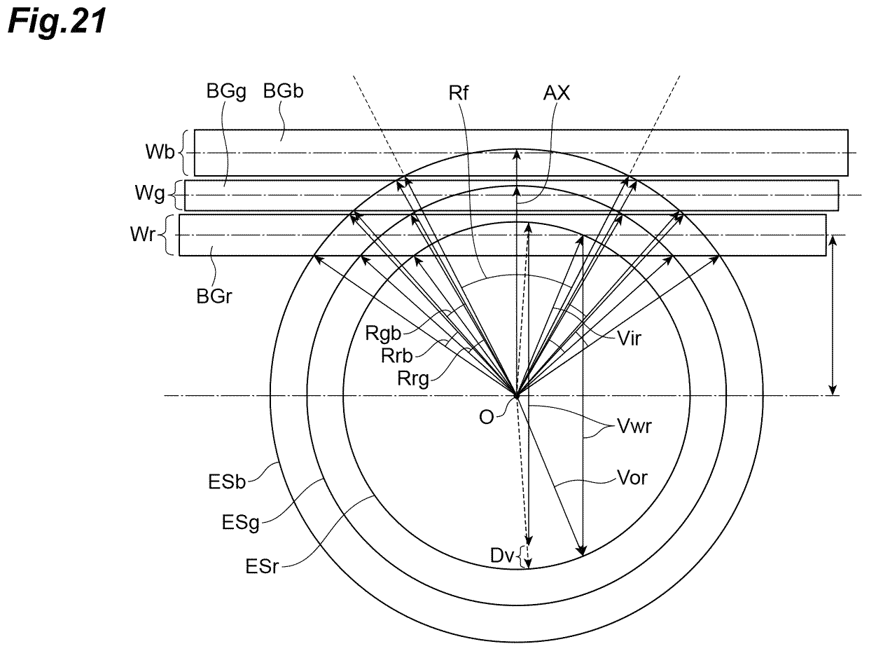

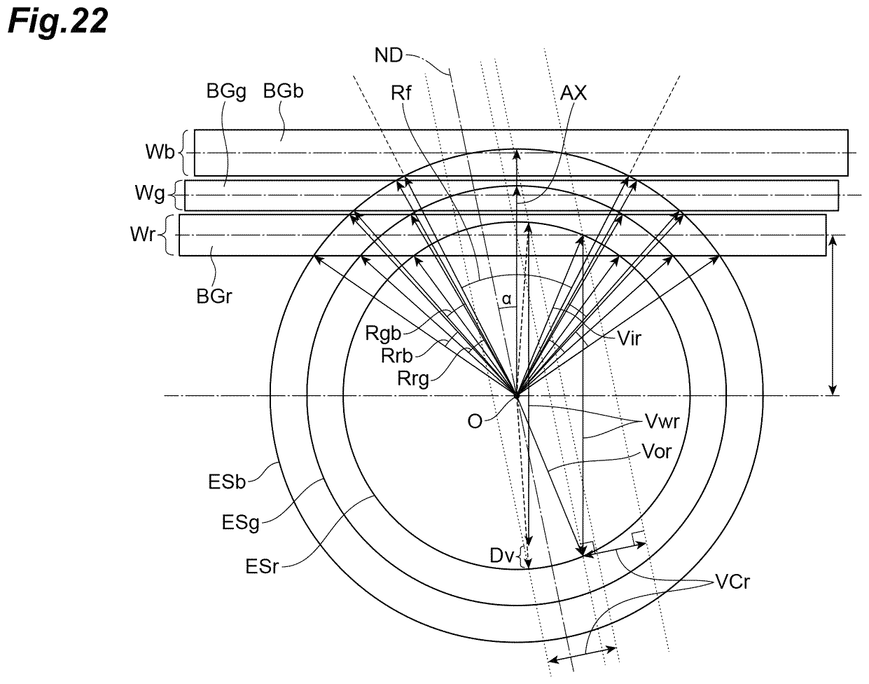

Here, the cholesteric liquid crystal polymer layer in the notch filter 13 will be described in detail with reference to FIGS. 21 and 22. FIG. 21 is a diagram showing the Ewald sphere of each color in the wave number space of light in the cross section including the wave vector in the helical axis direction of the cholesteric liquid crystal polymer layer and the wave vector of the center of the beam which is positioned at the center of the field of view of the incident light. The Ewald sphere ESr is an Ewald sphere of red light. The Ewald sphere ESg is an Ewald sphere of green light. The Ewald sphere ESb is an Ewald sphere of blue light. Here, the helical axis direction AX of the cholesteric liquid crystal polymer layer is perpendicular to the film surface.

The optical band gap of each cholesteric polymer liquid crystal layer can be set to a desired value by appropriately setting the helical pitch of each cholesteric liquid crystal polymer layer and the birefringence index of the liquid crystal by adjusting the composition (the type and amount of the chiral dopant, the birefringence index of the liquid crystal monomer, etc.) of each cholesteric liquid crystal polymer layer. In the following description, a case where the wavelength of red light is 620 nm, the wavelength of green light is 520 nm, and the wavelength of blue light is 450 nm is exemplified.

The optical band gap width W is approximated by Equation (1) using the half pitch P/2 and the extraordinary refractive index nₑ, the ordinary refractive index nₒ and the effective refractive index n_{eff} of the liquid crystal of the cholesteric liquid crystal polymer layer. The half pitch P/2 is a length at which the orientation directions of liquid crystal molecules rotate by 180 degrees along the helical axis of the cholesteric liquid crystal polymer layer, and is half of the helical pitch. The effective refractive index noir is approximated by the volume-average refractive index of the cholesteric liquid crystal polymer layer. The optical band gap width W is the magnitude of the optical band gap in the wave number space of the refractive index n_{eff}:

[Equation 1]

$$W = \frac{2 π}{P} {n}_{eff} ( \frac{1}{{n}_{o}} - \frac{1}{{n}_{e}} ) \qquad ( 1 )$$

Using the half pitch P/2, the wavelength λ of the incident light, the effective refractive index n_{eff}, and the incident angle θ, the Bragg condition is expressed by Equation (2). The incident angle θ is an angle formed by the helical axis and the wave vector of the incident light. Here, the magnitude of the wave vector of the incident light in the cholesteric liquid crystal polymer layer is n_{eff}×2π/λ. The direction of the wave vector of the incident light is the traveling direction of the incident light.

[Equation 2]

$$cos θ = \frac{λ}{{n}_{eff} P} \qquad ( 2 )$$

When the half pitch P_{R}/2, the extraordinary refractive index n_{Re}, the ordinary refractive index n_{Ro}, and the effective refractive index n_{Reff} of the cholesteric liquid crystal polymer layer for red light are used, the optical band gap width Wr of the optical band gap BGr of the cholesteric liquid crystal polymer layer for red light is expressed by Equation (3).

[Equation 3]

$$W r = \frac{2 π}{{P}_{R}} {n}_{Reff} ( \frac{1}{{n}_{R o}} - \frac{1}{{n}_{Re}} ) \qquad ( 3 )$$

Similarly, when the half pitch P_{G}/2, the extraordinary refractive index n_{Ge}, the ordinary refractive index n_{Go}, and the effective refractive index n_{Geff} of the cholesteric liquid crystal polymer layer for green light are used, the optical band gap width Wg of the optical band gap BGg of the cholesteric liquid crystal polymer layer for green light is expressed by Equation (4).

[Equation 4]

$$Wg = \frac{2 π}{{P}_{G}} {n}_{Geff} ( \frac{1}{{n}_{Go}} - \frac{1}{{n}_{G e}} ) \qquad ( 4 )$$

Similarly, when the half pitch P_{B}/2, the extraordinary refractive index n_{Be}, the ordinary refractive index n_{Bo}, and the effective refractive index n_{Beff} of the cholesteric liquid crystal polymer layer for blue light are used, the optical band gap width Wb of the optical band gap BGb of the cholesteric liquid crystal polymer layer for blue light is expressed by Equation (5).

[Equation 5]

$$W b = \frac{2 π}{{P}_{B}} {n}_{Beff} ( \frac{1}{{n}_{Bo}} - \frac{1}{{n}_{B e}} ) \qquad ( 5 )$$

When each cholesteric liquid crystal polymer layer causes Bragg reflection, the wave vector of the light changes by the Bragg wave vector of each cholesteric liquid crystal polymer layer, so that the emitted light is obtained. For example, the wave vector Vor of the emitted red light is obtained by combining the wave vector Vir of the incident red light and the Bragg wave vector V_{WT} of the cholesteric liquid crystal polymer layer for red light.

The magnitude of the Bragg wave vector V_{WT} of the cholesteric liquid crystal polymer layer for red light is 4π/P_{R}, and its direction is parallel to the helical axis direction AX. The magnitude of the Bragg wave vector Vwg of the cholesteric liquid crystal polymer layer for green light is 4π/P_{G}, and its direction is parallel to the helical axis direction AX. The magnitude of the Bragg wave vector Vwb of the cholesteric liquid crystal polymer layer for blue light is 4π/P_{B}, and its direction is parallel to the helical axis direction AX. The number of absolute values of the incident angles that satisfy the exact Bragg condition is 1 or 0 for each combination of wavelength and cholesteric liquid crystal polymer layer.

However, the cholesteric liquid crystal polymer layer has a finite optical band gap width that is not 0. As a result, light in a wave number space region having a finite thickness shown in FIG. 21 in the vicinity of a combination of an incident angle and a wavelength that satisfies the Bragg condition (this is referred to as “light within an optical band gap”) also causes the Bragg reflection. On the other hand, according to the uncertainty principle of the wave number, even if the material of the cholesteric liquid crystal polymer layer has a narrow optical band gap width, by reducing the film thickness of the cholesteric liquid crystal polymer layer, the uncertainty of the wave number can be increased and the region where the Bragg reflection occurs can be widened. However, in this case, the reflectance of the Bragg reflection is lowered and the light transmitted through the cholesteric liquid crystal polymer layer is increased. Although this technique cannot be used for the notch filter 13, it can be used for a holographic combiner or the like, and is effective when the transmittance is desired to be increased.

That is, incident light within a range in which the Bragg condition is relaxed for the optical band gap width in the wave number space causes the Bragg reflection. This is the reason why the Bragg reflection occurs in a certain range of incident angle as shown in FIG. 21. The change amount Dv in the wave vector at this time is different from the Bragg wave vector for incident light that does not satisfy the Bragg condition, but is along the helical axis direction AX when the helical axis direction AX is perpendicular to the film surface of the cholesteric liquid crystal polymer layer. On the other hand, when the helical axis direction AX is inclined with respect to the film surface of the cholesteric liquid crystal polymer layer, the above-described situation does not occur.

As shown in FIG. 22, the magnitude of the in-plane direction component of the Bragg wave vector is expressed by 4π×sin α/P using the magnitude 4π/P of the Bragg wave vector of the cholesteric liquid crystal polymer layer and the inclination angle α of the helical axis. For example, the in-plane direction component VCr due to the Bragg wave vector Vwr is expressed by 4π×sin α/P_{R}. The wave vector of the emitted light is determined so that the in-plane direction component of the Bragg wave vector becomes the in-plane direction component of the change amount of the wave vector.

By the energy conservation law and the approximation of the effective refractive index n_{eff} by the volume-average refractive index value of the cholesteric liquid crystal polymer layer as described above, the effective refractive index n_{eff} can be approximated without depending on the direction of the wave vector. This makes it possible to set a condition that the end points of the wave vectors of the incident light and the emitted light are located on the Ewald sphere, and the wave vector of the emitted light is uniquely determined with respect to the incident light from the above condition and the condition of the in-plane direction component of the change amount of the wave vector.

The relationship between the wave vector of the incident light and the wave vector of the emitted light is actually the same as that of a surface relief type diffraction grating having the wave vector of the magnitude of 4π×sin α/P. The difference between the above-mentioned relationship and the surface relief type diffraction grating is that only light within the optical band gap is diffracted, high-order extra diffraction hardly occurs, and only circularly polarized light of one polarity is diffracted.

A cholesteric liquid crystal manufactured for light having a long wavelength causes the Bragg reflection of light having a shorter wavelength only in a range of an incident angle larger than that of the light having the assumed long wavelength. For example, in the incident angle range Rrg, the cholesteric liquid crystal polymer layer for red light causes the Bragg reflection of green light. In the incident angle range Rrb, the cholesteric liquid crystal polymer layer for red light causes the Bragg reflection of blue light. In the incident angle range Rgb, the cholesteric liquid crystal polymer layer for green light causes the Bragg reflection of blue light. However, it is understood that there is no problem if the incident angle range in which the Bragg reflection of light having the shorter wavelength is caused is designed so as not to overlap with the incident angle range Rf. The incident angle range Rf is a range of incident angles that functions as a notch filter for all wavelengths of red, green, and blue light.

Here, the estimated incident angle range Rf is an incident angle in the cholesteric liquid crystal polymer layer having an effective refractive index of 1 or more, and not an incident angle from the atmosphere. Light enters the cholesteric liquid crystal polymer layer from the atmosphere with being refracted in accordance with the effective refractive index. Therefore, it is understood that by using a cholesteric liquid crystal polymer having a large effective refractive index, the incident angle range from the atmosphere can be widened.

In order to widen the incident angle range Rf of the notch filter 13, the helical axis direction AX of the cholesteric liquid crystal polymer layer is set to be as parallel as possible to the direction of the incident wave vector when the light ray at the center of the beam at the center of the field of view which reaches the center of the eye box enters the notch filter 13. Further, the installation angle of the notch filter 13 and the helical axis direction AX may be set such that the helical axis is perpendicular to the film surface while satisfying the above-described condition.

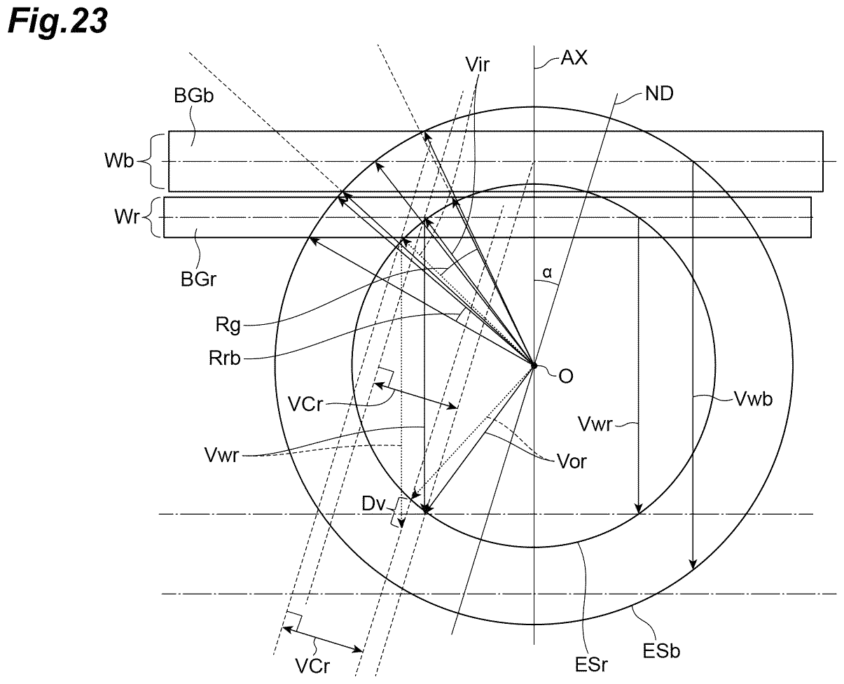

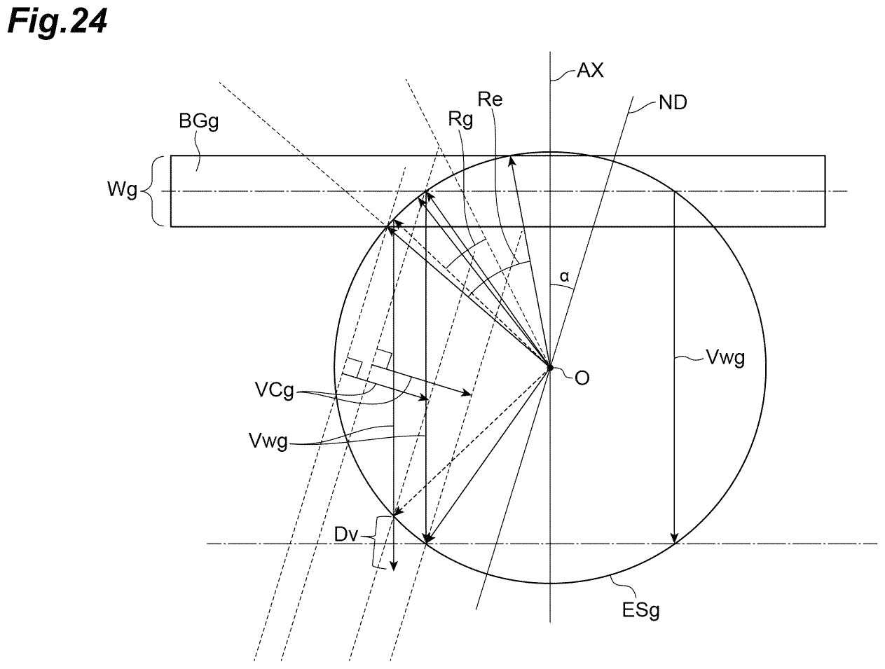

Next, the cholesteric liquid crystal polymer layer in the reflector 53 will be described in detail with reference to FIGS. 23 and 24. FIG. 23 is a diagram showing the wave number space of light and the Ewald spheres of blue light and red light in the cross section including the wave vector in the helical axis direction of the cholesteric liquid crystal polymer and the wave vector of the center of the beam which is positioned at the center of the field of view of the incident light. Here, it is assumed that the helical axis direction AX of the cholesteric liquid crystal polymer layer is inclined at an angle α with respect to the film surface. In FIGS. 23 and 24, for convenience of description, elements corresponding to the cholesteric liquid crystal polymer layer of the notch filter 13 are denoted by the same reference numerals, and redundant description is omitted.

Since circularly polarized red light and blue light having the same polarity enter the reflector 53, it is necessary to consider a wave number space for red light and blue light where the problem in wavelength selectivity arises. As described above, the cholesteric liquid crystal manufactured for light having a long wavelength causes the Bragg reflection of light having a shorter wavelength only in a range of an incident angle larger than that of the light having the assumed long wavelength. For example, in the incident angle range Rrb, the cholesteric liquid crystal polymer layer for red light causes the Bragg reflection of blue light. However, it is understood that there is no problem if the incident angle range Rrb is designed so as not to overlap with the incident angle range Rg1. The incident angle range Rg1 is a range of incident angles that functions as a diffraction grating for the wavelengths of red light and blue light.

Here, the estimated incident angle range Rg1 is an incident angle in the cholesteric liquid crystal polymer layer having an effective refractive index of 1 or more, and not an incident angle from the atmosphere. Light enters the cholesteric liquid crystal polymer layer from the atmosphere with being refracted in accordance with the effective refractive index. Therefore, it is understood that by using a cholesteric liquid crystal polymer having a large effective refractive index, the incident angle range from the atmosphere can be widened.

Since green light is circularly polarized light having a polarity different from that of red light and blue light, the problem in wavelength selectivity does not arise for green light. Thus, green light can be considered independent of red and blue light. As shown in FIG. 24, the optical band gap width Wg of the cholesteric liquid crystal polymer layer for green light may be widened as much as possible.

In the holographic combiner, in order to realize the function of the concave mirror, it is necessary to change the inclination α of the helical axis and the in-plane direction of the inclination depending on the location. The inclination α of the helical axis and the in-plane direction of the inclination can be controlled by the orientation pattern of the photoalignment layer. In order to obtain a wider viewing angle, the helical pitch may be changed depending on the location. For example, by applying an in-plane temperature distribution in a state before the cholesteric liquid crystal polymer layer is solidified by utilizing the temperature dependence of the helical pitch of the cholesteric liquid crystal, the helical pitch can be changed in accordance with the location. The helical pitch may be changed in accordance with the location by changing the chiral dopant concentration in accordance with the location using the ink jet method during application of the liquid crystal. The change in helical pitch corresponds to a change in the magnitude of the Bragg wave vector.

Furthermore, by changing the composition of the liquid crystal monomer for each cholesteric liquid crystal polymer layer and in accordance with the location by using the ink jet method during the application of the liquid crystal, the magnitude of birefringence of the liquid crystal monomer (here, the difference between the reciprocal of the ordinary refractive index and the reciprocal of the extraordinary refractive index) is controlled. Thus, the optical band gap width can be controlled for each cholesteric liquid crystal polymer layer and in accordance with the location. It may be necessary to control the optical band gap in conjunction with the control of the helical pitch.

When the incident angle with respect to the helical axis and the inclination α of the helical axis are substantially equal, light is emitted vertically from the holographic combiner. At this time, the incident angle with respect to the plane is approximately 2α.

It is desirable that the diffraction angles of light of three colors are aligned to eliminate chromatic aberration. When the Equation (6) is satisfied, the diffraction angles of light of the three colors are equal. The Equation (6) is expressed by using: the inclination α_{R} of the helical axis and the effective refractive index n_{Reff} of the cholesteric liquid crystal polymer layer for red light constituting the holographic diffraction layer 56; the inclination α_{G} of the helical axis and the effective refractive index n_{Geff} of the cholesteric liquid crystal polymer layer for green light constituting the holographic diffraction layer 55; the inclination β_{B} of the helical axis and the effective refractive index n_{Beff} of the cholesteric liquid crystal polymer layer for blue light constituting the holographic diffraction layer 54; the wavelength λ_{R} of red light; the wavelength λ_{G} of green light; and the wavelength λ_{B} of blue light.

[Equation 6]

$$\frac{{P}_{R}}{{λ}_{R} sin {α}_{R}} = \frac{{P}_{G}}{{λ}_{G} sin {α}_{G}} = \frac{{P}_{B}}{{λ}_{B} sin {α}_{B}} \qquad ( 6 )$$

Since it is concerned about the diffraction angle when light is emitted into the atmosphere, any effective refractive index is not included in Equation (6). The inclination α_{R} and the helical pitch P_{R} are directly determined by the exposure pattern of the photoalignment layer of the cholesteric liquid crystal polymer layer for red light. The inclination α_{G} and the helical pitch P_{G} are directly determined by the exposure pattern of the photoalignment layer of the cholesteric liquid crystal polymer layer for green light. The inclination α_{B} and the helical pitch P_{B} are directly determined by the exposure pattern of the photoalignment layer of the cholesteric liquid crystal polymer layer for blue light. Therefore, elimination of chromatic aberration can be easily realized.

Also in the retinal projection device 1E, the same effects as those of the retinal projection device 1A can be obtained in the configuration common to the retinal projection device 1A. In order to expand the eye box, it is necessary to widen the allowable range of the incident angle of the beam entering the optical device 5A. When a wide-band element having a wide allowable range of incident angle is used, the allowable range of wavelength is widened. Since the red wavelength and the green wavelength are close to each other and the green wavelength and the blue wavelength are close to each other, stray light due to chromatic aberration may occur when the allowable range of wavelength is widened. On the other hand, in the retinal projection device 1E, the notch filter 13 extracts the left-handed circularly polarized light from the red light Lr, extracts the right-handed circularly polarized light from the green light Lg, and extracts the left-handed circularly polarized light from the blue light Lb.

Since the holographic diffraction layer 54 reflects (scatters) the left-handed circularly polarized light, the right-handed circularly polarized light of the green light Lg is hardly reflected even if the allowable range of the wavelength of the holographic diffraction layer 54 is widened. Similarly, since the holographic diffraction layer 55 reflects the right-handed circularly polarized light, the left-handed circularly polarized light of the red light Lr and the left-handed circularly polarized light of the blue light Lb are hardly reflected even if the allowable range of the wavelength of the holographic diffraction layer 55 is widened. Similarly, since the holographic diffraction layer 56 reflects the left-handed circularly polarized light, the right-handed circularly polarized light of the green light Lg is hardly reflected even if the allowable range of the wavelength of the holographic diffraction layer 56 is widened. Since the red wavelength and blue wavelength are separated from each other, the holographic diffraction layers 54 and 56 can maintain wavelength selectivity. Therefore, the left-handed circularly polarized light of the red light Lr is hardly reflected by the holographic diffraction layer 54, and the left-handed circularly polarized light of the blue light Lb is hardly reflected by the holographic diffraction layer 56. Therefore, it is possible to reduce the possibility that stray light occurs due to chromatic aberration.

When the twisting direction of the twisted structure of the electric field vector having the light traveling direction as an axis at a certain time caused by the rotation of the electric field vector of circularly polarized light coincides with the twisting direction of the twisted structure in the orientation direction of the liquid crystal molecules of the cholesteric liquid crystal polymer layer, and the incident light satisfies a certain condition, the Bragg reflection occurs and the incident light is diffracted and reflected. On the other hand, if the twisting directions are opposite to each other, the incident light is transmitted without the Bragg reflection. As described above, circularly polarized light having a desired wavelength and a desired polarization state is reflected by adjusting the helical pitch (precisely, the product of the helical pitch and the effective refractive index of the cholesteric liquid crystal polymer layer) of the helical structure constituted by the liquid crystal molecules of the cholesteric liquid crystal polymer layer, the helical axis direction, the effective refractive index, the twisting direction, and the extraordinary refractive index and the ordinary refractive index of each layer obtained by slicing the cholesteric liquid crystal polymer layer in a plane perpendicular to the helical axis.

In the retinal projection device 1E, the filter layer 32 is configured to reflect the right-handed circularly polarized light from the blue light Lb, the filter layer 33 is configured to reflect the left-handed circularly polarized light from the green light Lg, and the filter layer 34 is configured to reflect the right-handed circularly polarized light from the red light Lr. Therefore, since it is possible to extract the left-handed circularly polarized light of the red light Lr, the right-handed circularly polarized light of the green light Lg, and the left-handed circularly polarized light of the blue light Lb, the function of the notch filter 13 can be realized.

The holographic diffraction layer 54 is configured to reflect the left-handed circularly polarized light of the blue light Lb, the holographic diffraction layer 55 is configured to reflect the right-handed circularly polarized light of the green light Lg, and the holographic diffraction layer 56 is configured to reflect the left-handed circularly polarized light of the red light Lr. Therefore, the function of the reflector 53 can be realized.

The notch filter 13 may be configured to pass the right-handed circularly polarized light of the red light Lr, to reflect the left-handed circularly polarized light of the red light Lr, to pass the left-handed circularly polarized light of the green light Lg, to reflect the right-handed circularly polarized light of the green light Lg, to pass the right-handed circularly polarized light of the blue light Lb, and to reflect the left-handed circularly polarized light of the blue light Lb. In this case, the optical device 5A is configured so as to scatter (reflect) the right-handed circularly polarized light in a wavelength range including the red wavelength, scatter (reflect) the left-handed circularly polarized light in a wavelength range including the green wavelength, and scatter (reflect) the right-handed circularly polarized light in a wavelength range including the blue wavelength.

Next, a method for manufacturing the cholesteric liquid crystal polymer layer (PVG) and the PBOE will be described. An example of an azo dye used in the alignment layer is Brilliant Yellow (CAS RN: 3051-11-4, product code: B0783 Brilliant Yellow: Brilliant Yellow 3051-11-4, Tokyo Chemical Industry Co., Ltd.). A solution obtained by dissolving brilliant yellow (BY) in dimethylformamide (DMF) is uniformly applied onto a transparent substrate 31 by spin coating and dried on a hot plate. The brilliant yellow molecules are oriented by the thin film obtained by the above-described process being exposed to an interference electric field of desired circularly polarized lights. Thus, an alignment layer is formed.

In the manufacture of PVG, a solution obtained by dissolving a reactive mesogen containing a chiral dopant and a photopolymerization initiator in a solvent such as toluene is applied onto an alignment layer, and then the solvent is evaporated to form a thin film. In the manufacture of PBOE, the same as above, but no chiral dopant is added. Thereafter, when the liquid crystal configuration is stabilized, the thin film is cured using UV light. If the thickness of the thin film obtained by one application of the solution is insufficient, the above-described application and curing are repeated until an appropriate thickness is obtained. In the case of PBOE, the thickness is controlled so as to function as a half-wave plate.

For the exposure of the alignment layer, for example, an exposure device described in Non-Patent Document 1 (Jianghao Xiong, Shin-Tson Wu, “Planar liquid crystal polarization optics for augmented reality and virtual reality: from fundamentals to applications”, eLight1, Article number: 3, 2021) is used. An example of a right-handed chiral dopant is R5011 (CAS NO. 944537-61-5 Chiral Dopant R5011, Daken Chemical Limited). An example of a left-handed chiral dopant is S5011 (CAS NO. 693227-30-4 Chiral Dopant S5011, Daken Chemical Limited). An example of reactive mesogen is reactive mesogen RM257 (CAS RN: 174063-87-7, product code: B5356, Tokyo Chemical Industry Co., Ltd.). By doping a chiral dopant, a helical structure perpendicular to the plane can be easily realized. The periodicity can be controlled by adjusting the twisting power of helix and concentration of the chiral dopant.

As a method for laminating a plurality of PVGs, there is the following method. After one PVG is formed on the transparent substrate 31, an intermediate layer is applied on the liquid crystal layer of the PVG so that the orientation of the liquid crystal layer does not affect above the intermediate layer. Then, a next PVG is formed on the intermediate layer. As another method for laminating a plurality of PVGs, after a PVG is formed on another substrate, the PVGs may be sequentially laminated on the same transparent substrate 31 by repeating transfer by adhesion and peeling.

The retinal projection device according to the present disclosure is not limited to the above-described embodiments.

The PBOE 44 may be constituted by a metasurface.

The configuration of the deflector 41 may be changed as long as the deflector 41 can change the traveling direction of the beam. The deflector 41 may be, for example, a reflector (mirror). The deflector 41 may change the traveling direction of the beam by controlling the wavefront using a spatial light modulator (SLM). Specifically, the deflector 41 may be a variable diffraction grating formed by the liquid crystal SLM.

### ADDITIONAL STATEMENTS

[Clause 1]

A retinal projection device comprising:
a projector module including a laser module configured to emit laser light, a collimation lens configured to convert the laser light into a parallel beam, and a movable mirror configured to perform scanning by the beam;
a projection lens configured to focus the beam emitted from the projector module at a focusing position;
an optical unit including a deflector, the deflector arranged so as to overlap the focusing position and configured to change a traveling direction of the beam;
an optical device configured to convert the beam into parallel light and irradiate a retina of a user with the parallel light; and
a controller configured to adjust the traveling direction of the beam by the deflector in accordance with a position of a pupil of the user.

[Clause 2]

The retinal projection device according to clause 1, further comprising a first wave plate provided between the laser module and the deflector and configured to convert linearly polarized light into circularly polarized light,
wherein the deflector comprises:
one or more second wave plates capable of switching between a state in which a polarization state of circularly polarized light is preserved and a state in which circularly polarized light is converted into circularly polarized light having an opposite polarity in accordance with an applied voltage; and
one or more Pancharatnam-Berry phase optical elements configured to convert circularly polarized light into circularly polarized light having an opposite polarity and diffract the circularly polarized light in a diffraction direction in accordance with a polarity of incident circularly polarized light, and
wherein the one or more second wave plates and the one or more Pancharatnam-Berry phase optical elements are alternately arranged one by one to form an array.

[Clause 3]

The retinal projection device according to clause 2,
wherein the deflector further comprises a reflector configured to reflect the circularly polarized light while preserving the polarity of the circularly polarized light, and
the reflector is provided at one end of the array.

[Clause 4]

The retinal projection device according to clause 2 or 3,
wherein the one or more Pancharatnam-Berry phase optical elements are constituted by liquid crystal polymers or metasurfaces.

[Clause 5]

The retinal projection device according to any one of clauses 2 to 4,
wherein each of the second wave plates comprises a pair of transparent electrodes and a liquid crystal layer provided between the pair of transparent electrodes.

[Clause 6]

The retinal projection device according to any one of clauses 1 to 5, further comprising a wavefront correction unit configured to correct a wavefront aberration of a light ray passing through the pupil among light rays constituting the beams.

[Clause 7]

The retinal projection device according to clause 6,
wherein the wavefront correction unit is constituted by one of an LCOS, a liquid crystal lens, and a deformable mirror.

[Clause 8]

The retinal projection device according to any one of clauses 1 to 7, further comprising a focusing area provided between the optical unit and the optical device, the focusing area configured to focus the beam.

[Clause 9]

The retinal projection device according to any one of clauses 1 to 8,
wherein the laser module emits the laser light obtained by multiplexing a red laser light having a red wavelength, a green laser light having a green wavelength, and a blue laser light having a blue wavelength.

[Clause 10]

The retinal projection device according to clause 9, further comprising a filter configured to:
pass circularly polarized light having a first polarity in light having the red wavelength;
reflect circularly polarized light having a second polarity different from the first polarity in the light having the red wavelength;
pass circularly polarized light having the second polarity in light having the green wavelength;
reflect circularly polarized light having the first polarity in the light having the green wavelength;
pass circularly polarized light having the first polarity in light of the blue wavelength; and
reflect circularly polarized light having the second polarity in the light of the blue wavelength,
wherein the optical device is a holographic combiner, and
wherein the optical device comprises:
a first holographic diffraction layer configured to diffract circularly polarized light having the first polarity in a first wavelength range including the red wavelength;
a second holographic diffraction layer configured to diffract circularly polarized light having the second polarity in a second wavelength range including the green wavelength; and
a third holographic diffraction layer configured to diffract circularly polarized light having the first polarity in a third wavelength range including the blue wavelength.

[Clause 11]

The retinal projection device according to clause 10,
wherein the first holographic diffraction layer is constituted by a cholesteric liquid crystal polymer layer having a helical structure having a helical pitch corresponding to the red wavelength, the helical structure twisted in a twisting direction capable of reflecting circularly polarized light having the first polarity,
wherein the second holographic diffraction layer is constituted by a cholesteric liquid crystal polymer layer having a helical structure having a helical pitch corresponding to the green wavelength, the helical structure twisted in a twisting direction capable of reflecting circularly polarized light having the second polarity, and
wherein the third holographic diffraction layer is constituted by a cholesteric liquid crystal polymer layer having a helical structure having a helical pitch corresponding to the blue wavelength, the helical structure twisted in a twisting direction capable of reflecting circularly polarized light having the first polarity.

[Clause 12]

The retinal projection device according to clause 10 or 11,
wherein the filter comprises:
a first filter layer constituted by a first cholesteric liquid crystal polymer layer having a helical structure having a helical pitch corresponding to the red wavelength, the helical structure twisted in a twisting direction capable of reflecting circularly polarized light having the second polarity;
a second filter layer constituted by a second cholesteric liquid crystal polymer layer having a helical structure having a helical pitch corresponding to the green wavelength, the helical structure twisted in a twisting direction capable of reflecting circularly polarized light having the first polarity; and
a third filter layer constituted by a third cholesteric liquid crystal polymer layer having a helical structure having a helical pitch corresponding to the blue wavelength, the helical structure twisted in a twisting direction capable of reflecting circularly polarized light having the second polarity.

What is claimed is:

1. A retinal projection device comprising:
a projector module including a laser module configured to emit laser light, a collimation lens configured to convert the laser light into a parallel beam, and a movable mirror configured to perform scanning by the beam;
a projection lens configured to focus the beam emitted from the projector module at a focusing position;
an optical unit including a deflector, the deflector arranged so as to overlap the focusing position and configured to change a traveling direction of the beam;
an optical device configured to convert the beam into parallel light and irradiate a retina of a user with the parallel light; and
a controller configured to adjust the traveling direction of the beam by the deflector in accordance with a position of a pupil of the user.

2. The retinal projection device according to claim 1, further comprising a first wave plate provided between the laser module and the deflector and configured to convert linearly polarized light into circularly polarized light,
wherein the deflector comprises:
one or more second wave plates capable of switching between a state in which a polarization state of circularly polarized light is preserved and a state in which circularly polarized light is converted into circularly polarized light having an opposite polarity in accordance with an applied voltage; and
one or more Pancharatnam-Berry phase optical elements configured to convert circularly polarized light into circularly polarized light having an opposite polarity and diffract the circularly polarized light in a diffraction direction in accordance with a polarity of incident circularly polarized light, and
wherein the one or more second wave plates and the one or more Pancharatnam-Berry phase optical elements are alternately arranged one by one to form an array.

3. The retinal projection device according to claim 2,
wherein the deflector further comprises a reflector configured to reflect the circularly polarized light while preserving the polarity of the circularly polarized light, and
the reflector is provided at one end of the array.

4. The retinal projection device according to claim 2,
wherein the one or more Pancharatnam-Berry phase optical elements are constituted by liquid crystal polymers or metasurfaces.

5. The retinal projection device according to claim 2,
wherein each of the second wave plates comprises a pair of transparent electrodes and a liquid crystal layer provided between the pair of transparent electrodes.

6. The retinal projection device according to claim 1, further comprising a wavefront correction unit configured to correct a wavefront aberration of a light ray passing through the pupil among light rays constituting the beams.

7. The retinal projection device according to claim 6,
wherein the wavefront correction unit is constituted by one of an LCOS, a liquid crystal lens, and a deformable mirror.

8. The retinal projection device according to claim 1, further comprising a focusing area provided between the optical unit and the optical device, the focusing area configured to focus the beam.

9. The retinal projection device according to claim 1,
wherein the laser module emits the laser light obtained by multiplexing a red laser light having a red wavelength, a green laser light having a green wavelength, and a blue laser light having a blue wavelength.

10. The retinal projection device according to claim 9, further comprising a filter configured to:
pass circularly polarized light having a first polarity in light having the red wavelength;
reflect circularly polarized light having a second polarity different from the first polarity in the light having the red wavelength;
pass circularly polarized light having the second polarity in light having the green wavelength;
reflect circularly polarized light having the first polarity in the light having the green wavelength;
pass circularly polarized light having the first polarity in light of the blue wavelength; and
reflect circularly polarized light having the second polarity in the light of the blue wavelength,
wherein the optical device is a holographic combiner, and
wherein the optical device comprises:
a first holographic diffraction layer configured to diffract circularly polarized light having the first polarity in a first wavelength range including the red wavelength;
a second holographic diffraction layer configured to diffract circularly polarized light having the second polarity in a second wavelength range including the green wavelength; and
a third holographic diffraction layer configured to diffract circularly polarized light having the first polarity in a third wavelength range including the blue wavelength.

11. The retinal projection device according to claim 10,
wherein the first holographic diffraction layer is constituted by a cholesteric liquid crystal polymer layer having a helical structure having a helical pitch corresponding to the red wavelength, the helical structure twisted in a twisting direction capable of reflecting circularly polarized light having the first polarity,
wherein the second holographic diffraction layer is constituted by a cholesteric liquid crystal polymer layer having a helical structure having a helical pitch corresponding to the green wavelength, the helical structure twisted in a twisting direction capable of reflecting circularly polarized light having the second polarity, and
wherein the third holographic diffraction layer is constituted by a cholesteric liquid crystal polymer layer having a helical structure having a helical pitch corresponding to the blue wavelength, the helical structure twisted in a twisting direction capable of reflecting circularly polarized light having the first polarity.

12. The retinal projection device according to claim 10,
wherein the filter comprises:
a first filter layer constituted by a first cholesteric liquid crystal polymer layer having a helical structure having a helical pitch corresponding to the red wavelength, the helical structure twisted in a twisting direction capable of reflecting circularly polarized light having the second polarity;
a second filter layer constituted by a second cholesteric liquid crystal polymer layer having a helical structure having a helical pitch corresponding to the green wavelength, the helical structure twisted in a twisting direction capable of reflecting circularly polarized light having the first polarity; and
a third filter layer constituted by a third cholesteric liquid crystal polymer layer having a helical structure having a helical pitch corresponding to the blue wavelength, the helical structure twisted in a twisting direction capable of reflecting circularly polarized light having the second polarity.
